(19) United States
(12) Patent Application Publication
(10) Pub. No.: US 2001/0027398 A1
(43) Pub. Date: Oct. 4, 2001

(54) COMMUNICATION SYSTEM FOR COMMUNICATING VOICE AND IMAGE DATA, INFORMATION PROCESSING APPARATUS AND METHOD, AND STORAGE MEDIUM

(75) Inventor: AKIHIRO KOHNO, TOKYO (JP)

Correspondence Address: MORGAN & FINNEGAN, 345 PARK AVENUE, NEW YORK, NY, 10154

(73) Assignee: Canon Kabushiki Kaisha

(21) Appl. No.: 08/975,214

(22) Filed: Nov. 20, 1997

(30) Foreign Application Priority Data
Nov. 29, 1996 (JP) 8-319516
Sep. 18, 1997 (JP) 9-253434

(51) Int. Cl. G10L 21/00

(52) U.S. Cl. 704/275

(57) ABSTRACT

An object of the present invention is to perform, in a communication system or apparatus which can communicate an image and a voice, image displaying and voice outputting which are convenient to an operator or a user, and concretely to provide technique which can conveniently or easily direct or teach to the operator importance of the image and the voice to be communicated.

In order to achieve the object, it is provided in the present invention a communication system comprising a transmission apparatus for transmitting an image and a voice to be added to the image, and a reception apparatus for receiving the image and the voice, wherein the transmission apparatus comprises a transmission means capable of selectively transmitting the image and the voice to the reception apparatus, and the reception apparatus comprises a control means for controlling the image received from the transmission apparatus and causing a predetermined display means to display the controlled image, on the basis of the voice transmitted by the transmission apparatus.

### BACKGROUND OF THE INVENTION

1. Field of the Invention

The present invention relates to a communication system, an information processing apparatus and an information processing method which can communicate an image or a voice, and a storage medium which stores this method.

2. Related Background Art

In recent years, an image and a voice can be transmitted and received (i.e., managed) among plural information processing apparatuses through a communication line. For example, the image and the voice can be transmitted and received among plural personal computers connected to the communication line, by using an internet or the like.

In such case of managing image data, it is necessary to reduce data capacity as much as possible. In order to do so, when moving image data (or dynamic image data) is managed, a method for reducing a frame rate has been known. Also, it has been known technique to compress the moving image data and still image data themselves by using an MPEG (motion picture expert group) system, a JPEG (joint photographic expert group) system and the like.

Conventionally, when a reception-side apparatus received the image and the voice transmitted from a transmission side, the reception-side apparatus has caused a monitor to display the image and caused a speaker to output the voice, whereby contents of the image and the voice have been known or recognized by an operator. Therefore, the operator has determined importance of the image and the voice by confirming such the contents thereof as occasion arose.

Further, the operator has properly set quality of the image displayed on the monitor.

As described above, usage of the conventional apparatus capable of communicating the image and the voice has been poor.

### SUMMARY OF THE INVENTION

The present invention is made in consideration of the above-described related background art, and an object thereof is to perform, in a communication system or apparatus which can communicate an image and a voice, image displaying and voice outputting which are convenient to an operator or a user.

Concretely, the object of the present invention is to provide technique which can conveniently or easily direct or teach to the operator importance of the image or the voice to be communicated.

In order to achieve the above object, according to one preferred embodiment of the present invention, it is provided a communication system comprising a transmission apparatus for transmitting the image and the voice to be added to such the image, and a reception apparatus for receiving such the image and the voice, wherein

the transmission apparatus comprises a transmission means capable of selectively transmitting the image and the voice to the reception apparatus, and

the reception apparatus comprises a control means for controlling the image received from the transmission apparatus and causing a predetermined display means to display the controlled image, on the basis of the voice transmitted by the transmission apparatus.

An another object of the present invention is to display the received image of which importance is probably high or which the user is probably interested in, in a state that the user can conveniently or easily watch the displayed image.

In order to achieve the above object, according to one preferred embodiment of the present invention, it is provided a communication system comprising a transmission apparatus for transmitting the image and the voice to be added to such the image, and a reception apparatus for receiving such the image and the voice, wherein

the transmission apparatus comprises,

a data amount control means for controlling a data amount of the image on the basis of a level of the voice to be added to such the image, and

a transmission means for transmitting the image of which data amount was controlled by the data amount control means, and

the reception apparatus comprises,

a reception means for receiving the image transmitted by the transmission means, and

a display control means for causing a predetermined display means to display the image received by the reception means.

The above and other objects, features, and advantages of the present invention will be apparent from the following detailed description and the appended claims in conjunction with the accompanying drawings.

### BRIEF DESCRIPTION OF THE DRAWINGS

FIG. 1 is a block diagram showing an entire system used in embodiments of the present invention;

FIG. 2 is a block diagram showing an entire system basing the embodiments of the present invention;

FIG. 3 is a flow chart of a still image transmission process;

FIG. 4 is a flow chart of a moving image transmission process;

FIG. 5 is a flow chart of an information switch program;

FIG. 6 is a flow chart showing execution procedure of the information switch program in a first embodiment;

FIG. 7 is a view showing an example of displaying used to designate a transmission site and select information intended to be received and displayed;

FIG. 8 is a view showing an example of simultaneously displaying the moving image and the still image received from the plural transmission sites;

FIG. 9 is a flow chart of the information switch program in a second embodiment;

FIG. 10 is a flow chart of the information switch program in a third embodiment;

FIG. 11 is a flow chart of the information switch program in a fourth embodiment;

FIG. 12 is a flow chart of the information switch program in a fifth embodiment;

FIG. 13 is a view showing an example of a camera control window in the fifth embodiment;

FIG. 14 is a block diagram showing a system used in a sixth embodiment;

FIG. 15 is a block diagram showing a basic system;

FIG. 16 is a flow chart of a still image delivery process;

FIG. 17 is a flow chart of a moving image delivery process;

FIG. 18 is a flow chart showing operation procedure of an information switch program 380′;

FIG. 19 is a flow chart showing operation procedure of an information switch program 381′;

FIG. 20 is a view showing an example of an image plane used to designate a transmission site 8′ and select received information in the embodiments;

FIG. 21 is a view showing an example of a display image plane of a reception site 9′ in the embodiments;

FIG. 22 is a flow chart showing operation procedure of an information switch program 382′;

FIG. 23 is a flow chart showing operation procedure of an information switch program 383′;

FIG. 24 is a flow chart showing operation procedure of an information switch program 384′;

FIG. 25 is a block diagram showing a system used in a seventh embodiment;

FIG. 26 is a block diagram showing a system used in an eighth embodiment; and

FIG. 27 is a block diagram showing a system used in a ninth embodiment.

### DETAILED DESCRIPTION OF PREFERRED EMBODIMENTS

### First Embodiment

Hereinafter, the first embodiment of the present invention will be explained with reference to accompanying drawings.

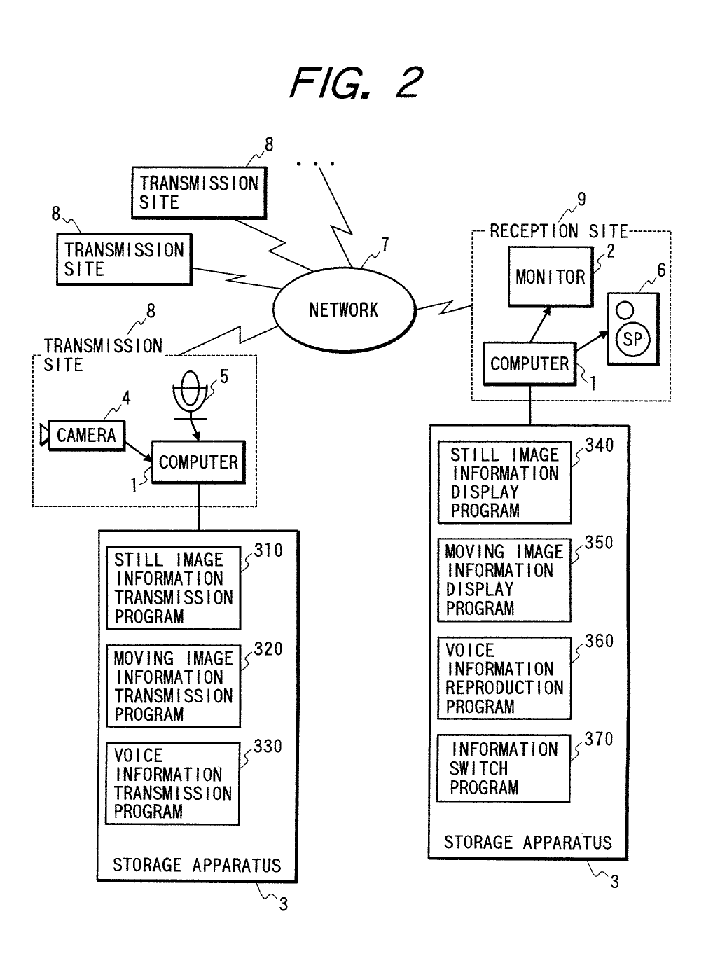

FIG. 2 is a block diagram of an entire communication system which bases the present embodiment.

In FIG. 2, reference numeral 1 denotes a computer such as a personal computer, a work station or the like which has a CPU; 2 denotes a monitor such as a CRT display or the like; 3 denotes a storage apparatus which stores and holds a program and data; 4 denotes a camera which photographs or takes an image; 5 denotes a microphone which inputs a voice; 6 denotes a speaker which outputs the voice; 7 denotes a network; 8 denotes a transmission site; and 9 denotes a reception site.

In the storage apparatus 3 of the transmission site 8, a still image information transmission program 310, a moving image information transmission program 320 and a voice information transmission program 330 are stored.

In the storage apparatus 3 of the reception site 9, a still image information display program 340, a moving image information display program 350, a voice information reproduction program 360 and an information switch program 370 are stored.

The still image information transmission program 310 is the program which is used to capture or obtain a still image from the camera 4 into the computer 1 through a video board, and transmit still image information through the network 7.

The moving image information transmission program 320 is the program which is used to capture or obtain a moving image from the camera 4 into the computer 1 through the video board, and transmit moving image information through the network 7.

The voice information transmission program 330 is the program which is used to capture or obtain the voice from the microphone 5 into the computer 1 through a sound board, and transmit voice information through the network 7.

The still image information display program 340 is the program which is used to receive the still image information through the network 7, and display the still image on the monitor 2 of the computer 1.

The moving image information display program 350 is the program which is used to receive the moving image information through the network 7, and display the moving image on the monitor 2 of the computer 1.

The voice reproduction program 360 is the program which is used to receive the voice information through the network 7, reproduce the voice by the computer 1, and output the reproduced voice by the speaker 6.

These programs are read and initiated by the computers 1 of the transmission site 8 and the reception site 9, whereby the still image, the moving image and the voice can be transmitted.

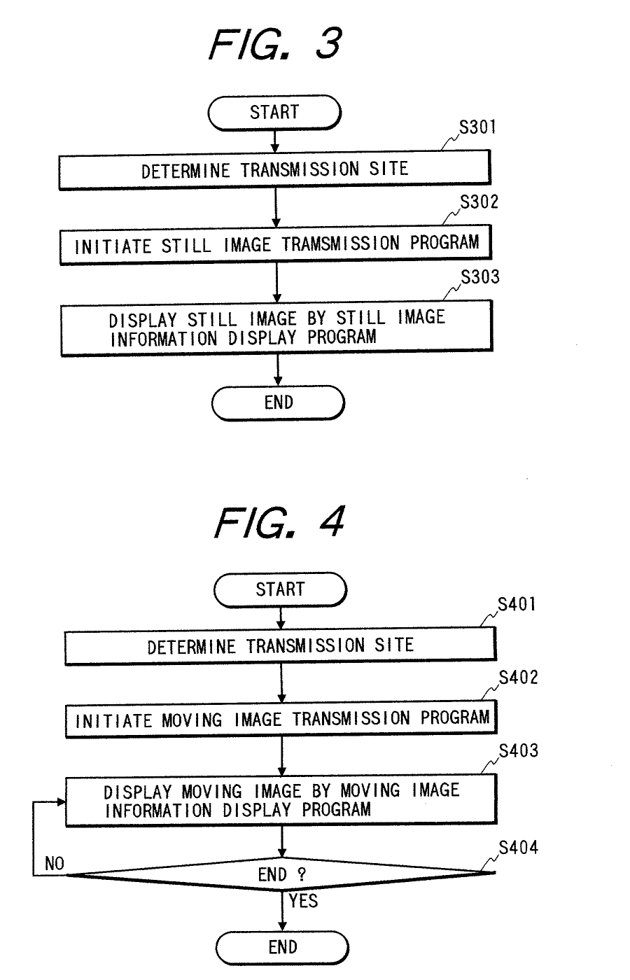

The still image is transmitted on the basis of, e.g., a flow chart shown in FIG. 3.

When the reception site 9 wishes to receive and display the still image from any of the plural transmission sites, the site 9 designates any of the transmission sites and transmits such a fact to the designated site (e.g., transmission site 8) (step S301).

Then, when the designated transmission site (e.g., transmission site 8) detects the fact that own site was designated, the site 8 initiates the still image information transmission program 310 to transmit the still image (i.e., still image information) to the reception site 9 (step S302).

Subsequently, the reception site 9 displays on its monitor 2 the still image information received through the network 7, by initiating the still image information display program 340 (step S303).

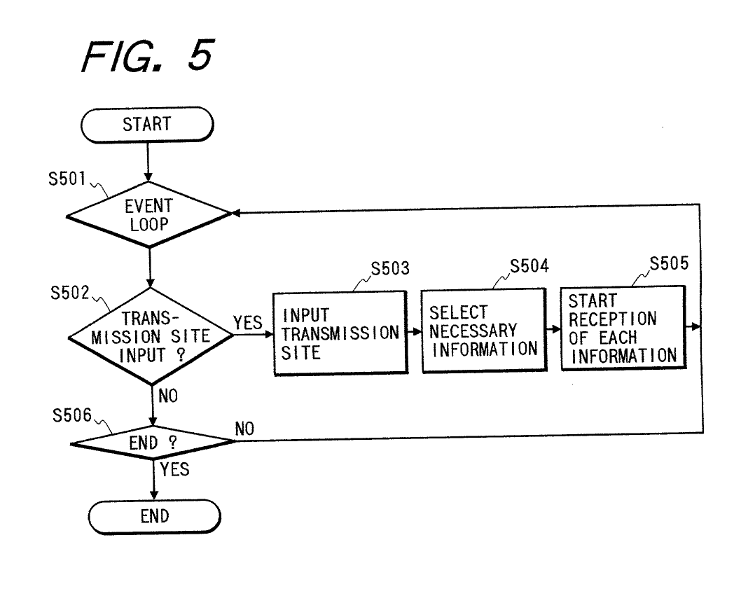

Like the still image, the moving image is also transmitted on the basis of a flow chart shown in FIG. 4.

When the reception site 9 wishes to receive and display the moving image from any of the transmission sites, the site 9 designates the transmission site and transmits such a fact to the designated site (e.g., transmission site 8) (step S401).

The transmission site, which received and detected the fact that own site had been designated, initiates the moving image information transmission program 320 to transmit the moving image (i.e., moving image information) to the reception site 9 (step S402).

Subsequently, the reception site 9 displays on its monitor 2 the moving image information received through the network 7, by initiating the moving image information display program 350 (step S403).

Such the moving image can be displayed until the reception site 9 detects that the moving image terminates (step S404).

It should be noted that the voice can be transmitted by the same process as that of FIG. 4 for transmitting the moving image.

Subsequently, the information switch program 370 stored in the storage apparatus 3 of the reception site 9 will be explained hereinafter.

FIG. 5 shows executing procedure of the information switch program 370.

When the information switch program 370 is initiated, the flow waits for an input event such as key inputting, mouse clicking or the like (step S501).

Then, it is judged in a step S502 whether or not there is the operator's inputting to designate the transmission site. If yes, the transmission site is designated based on such the inputting (step S503). Subsequently, the information required by the reception site 9 is selected by the operator from among the still image information, the moving image information and the voice information, and such a fact is transmitted to the transmission site 8 (step S504).

Since the transmission site 8 transmits the information according to such the selecting, this information is received by the reception site 9 hereafter (step S505).

When a termination event occurs (step S506), the information switch program 370 terminates.

Subsequently, the feature of the present invention will be explained in detail with reference to the accompanying drawings.

The system of the present invention includes the plural transmission sites 8, and the images can be received in parallel from these transmission sites 8 and displayed on the monitor 2. Therefore, as shown in FIG. 8, when the still images and/or the moving images are actually received in parallel from the plural transmission sites 8 (e.g., transmission sites A, B and C), the received still images and/or the moving images are simultaneously displayed on three different windows 12.

Further, in addition to the image, the voice to be added to such the received image can be also received. Therefore, in FIG. 8, the three different voices from the three transmission sites A, B and C are simultaneously outputted or produced from the speaker 6.

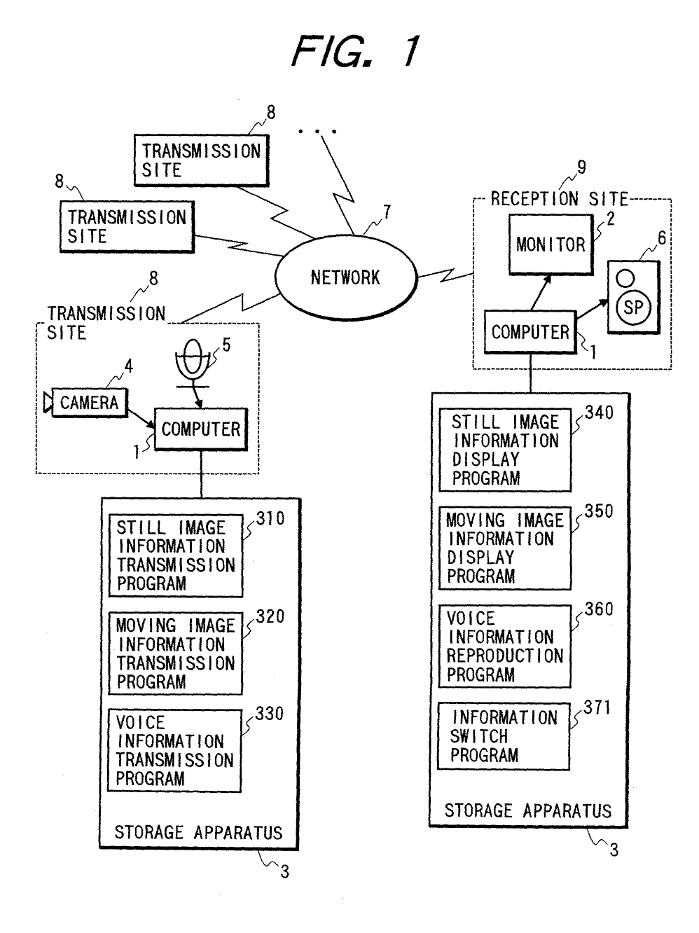

FIG. 1 is a block diagram showing an entire communication system which is obtained by replacing the information switch program 370 in the system of FIG. 2 by an information switch program 371. Therefore, since the system structure shown in FIG. 1 is substantially the same as that shown in FIG. 2, only execution procedure of the replaced information switch program 371 will be explained in detail hereinafter.

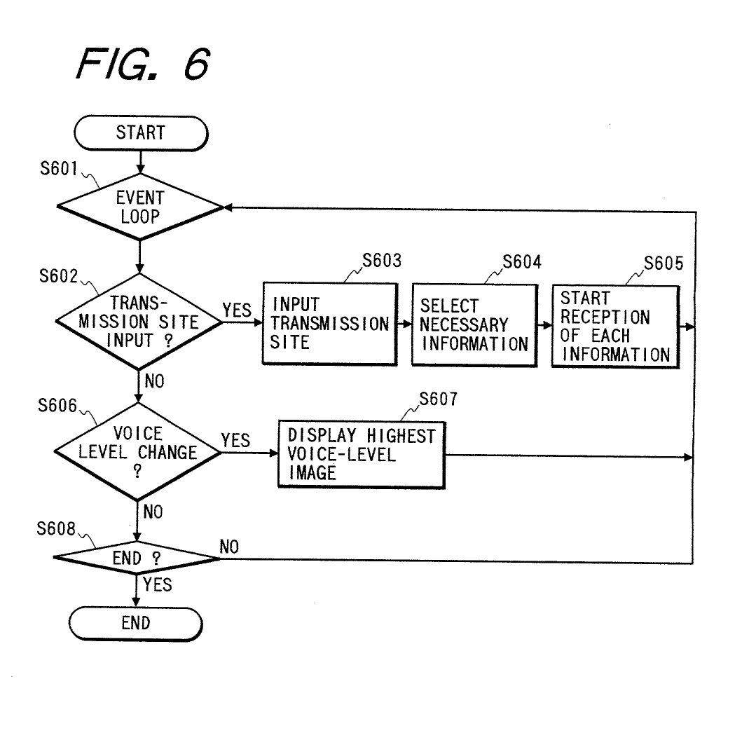

FIG. 6 is a flow chart showing execution procedure of the information switch program 371.

When the information switch program 371 is initiated, the flow waits for an input event such as key inputting, mouse clicking or the like (step S601).

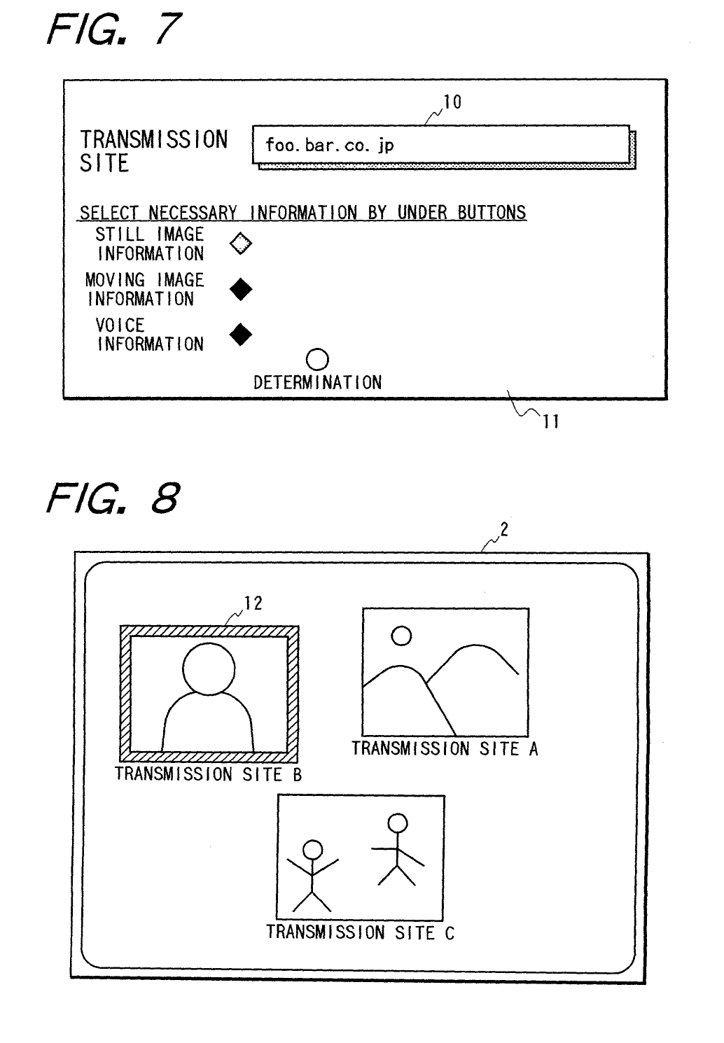

Then, in a step S602, when the input event occurs, an image is displayed on the monitor 2, in a form shown in FIG. 7, and the flow stands by until the operator inputs the transmission site into a transmission site designation portion 10 by using a keyboard of the computer 1 (step S603).

When the transmission site is inputted in the step S603, the flow stands by until any of still image, moving image and voice buttons 11 of FIG. 7 is selected and a determination button is depressed by the operator (step S604).

The present invention is not limited to the above operation in which only one of the buttons 11 is selected. That is, two buttons may be selected. For example, when the voice and still image buttons or the voice and moving image buttons are selected, the reception site 9 can receive the still image with the voice or the moving image with the voice.

When the information is selected in the step S604, such a fact is transmitted to the transmission site 8. Then, any of the still image, the moving image and the voice which is corresponding to the selecting is received from such the transmission site 8, the received still image or the moving image is displayed on the monitor 2, and the received voice is outputted from the speaker 6 (step S605). For example, if the images are received from the three transmission sites 8, such the image plane as shown in FIG. 8 is displayed on the monitor 2.

Subsequently, when the still image or the moving image is received and displayed, it is judged whether or not a voice level of the voice added to the received image changes (step S606). In this case, it should be noted that such the voice is the voice to be added in case of receiving the image and is the voice captured or obtained from the microphone 5 of the transmission site 8.

When it is judged in the step S606 that the voice level changed, one of the three images in FIG. 8 of which voice level is highest (to be referred as highest voice-level image hereinafter) is emphasized and displayed (step S607).

In FIG. 8, the voice added to the image of the transmission site B has the highest level, an outer frame of this image is emphasized by a fat line. Thus, the highest voice-level image, i.e., the interested image which probably most changed, can be displayed in a state easy to be perceived visibly.

Further, the highest voice-level image may be displayed in high resolution. By such displaying, only the interested image which probably most changed can be displayed as a highly precise image. In this case, since the images other than the highest voice-level image can be displayed in low resolution, a load of the image process can be reduced.

Furthermore, only the highest voice-level image may be displayed in color. By such displaying, only the interested image which probably most changed can be displayed in good or satisfactory image quality. In this case, since the images other than the highest voice-level image can be displayed in monochrome, the load of the image process can be reduced. Moreover, even if only the highest voice-level image is displayed as a 16-bit (gradation) color image and the other images are displayed as 8-bit (gradation) color images, the same effect as above can be derived.

Furthermore, the highest voice-level image may be enlarged and then displayed. By such displaying, only the interested image which probably most changed can be displayed as a large image. In this case, since the images other than the highest voice-level image can be displayed as same-size or reduced images, the load of the image process can be reduced.

Furthermore, when the highest voice-level image is selected and projected from a projector or displayed on a large image plane monitor (projector or monitor is provided independently), the interested image which probably most changed can be selectively displayed in large.

Furthermore, only the highest-level voice may be outputted from the speaker 6. By such outputting, only the voice corresponding to the interested image which probably most changed can be made easy to be listened.

Furthermore, controlling may be performed such that the highest-level voice is outputted from the speaker 6 in higher volume than those of the other voices. By such the controlling, the same effect as above can be derived.

Finally, when a termination event occurs in a step S606, the information switch program 371 terminates.

In the step S607, the above process is performed on the image corresponding to the voice of which level is highest (i.e., highest voice-level image). However, the above process may be performed on all the images corresponding to the voice of which level is equal to or higher than a predetermined value.

Further, the above process may be performed on the image corresponding to the voice of which level highly changed. By this process, the image which is supposed that it highly changed since the voice highly changed can be displayed in the state easy to be perceived by the operator.

Furthermore, the above process may be performed on all the images corresponding to the voice of which level is equal to or smaller than the predetermined value. By this process, the image information from the transmission site which is supposed to be not so important can be displayed in the state easy to be perceived by the operator.

### Second Embodiment

Hereinafter, a modified embodiment of the first embodiment will be concretely explained as the second embodiment. In the present embodiment, it will be explained a system in which initial setting has been performed to receive both the moving image and the voice.

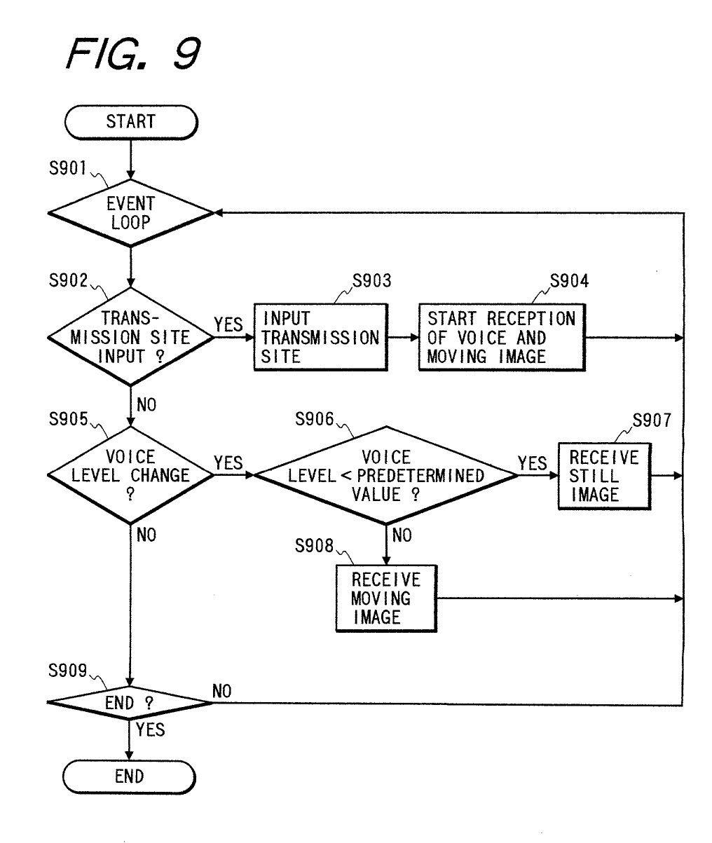

In the present embodiment, since only execution procedure of an information switch program is slightly different from the execution procedure of the information switch program 371 of FIG. 1, the concrete explanation of the system itself is omitted. The information switch program in the present embodiment is called as an information switch program 372 hereinafter. FIG. 9 is a flow chart of the information switch program 372.

When the information switch program 372 is initiated, the flow waits for the input event such as key inputting, mouse clicking or the like (step S901).

When the input event occurs (step S902), the transmission site is designated (step S903), and the moving image information and the voice information are received from the designated transmission site 8 and displayed (step S904).

Then, when the voice level of the received and displayed image changed (step S905), if such the voice level is lower than a predetermined value (step S906), the controlling is performed such that the still image is received from such the transmission site 8. In other words, a still image transmission instruction is transmitted to the transmission site 8, and then the still image transmitted according to this instruction is received and displayed (step S907).

On the other hand, if the voice level is higher than the predetermined value, the controlling is performed such that the moving image is received from such the transmission site 8. In other words, a moving image transmission instruction is transmitted to the transmission site 8, and then the moving image transmitted according to this instruction is received and displayed (step S908).

Therefore, the voice level of the voice which was added to the displayed image is firstly judged. In this case, although the still image or the moving image can be displayed, it is assumed that the moving image is displayed as an initial image. Then, if the voice level is low, it is judged that such the image is not so important, whereby the still image is displayed. On the other hand, if the voice level is high, it is judged that such the image is important, whereby the moving image is displayed. As a result, the important image can be real-time-displayed.

Finally, when the termination event occurs (step S909), the information switch program 372 terminates.

In the present embodiment, the initial setting has been performed to receive both the moving image and the voice. However, even if the initial setting is performed to receive both the still image and the voice, the same effect as above can be derived.

In the above-described embodiments, the information switch programs 370 and 371 are stored at the side of the reception site 9. However, steps (i.e., processes) of each program may be divisionally performed by both the transmission site 8 and the reception site 9, by dividing these steps into those to be performed by the transmission site 8 and those to be performed by the reception site 9.

According to the present embodiment, the image of which importance is supposed to be low is received and displayed as the still image, data transfer efficiency can be improved.

### Third Embodiment

It should be noted that basic system structure in the present embodiment is the same as that shown in FIG. 1. The feature of the present embodiment is that, in case of receiving and displaying the still image information, the still image at the time when the voice level of the transmission site becomes high is newly received from such the transmission site.

Hereinafter, the present invention will be explained with reference to the accompanying drawings.

The entire block diagram of the present embodiment is illustrated in FIG. 1. Therefore, in the present embodiment, since only execution procedure of an information switch program is slightly different from the execution procedure of the information switch program 371 of FIG. 1, the concrete explanation of the system structure itself is omitted. The information switch program in the present embodiment is called as an information switch program 373 (not shown) hereinafter.

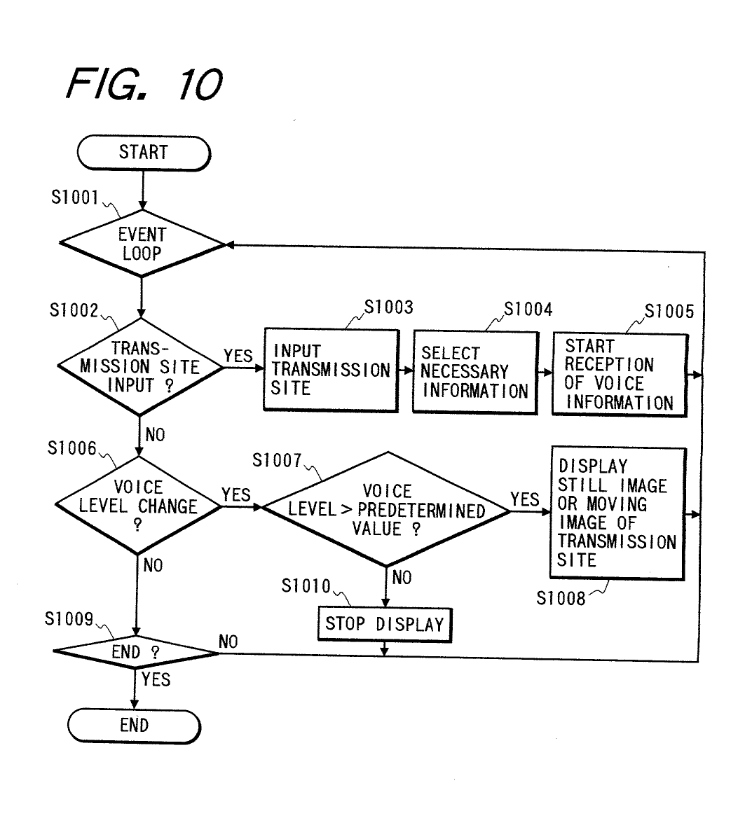

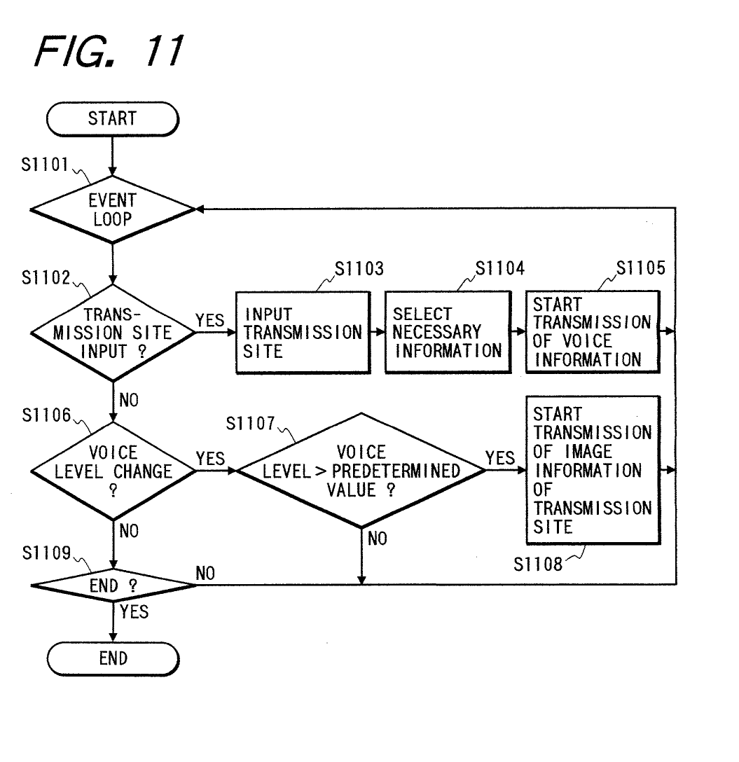

FIG. 10 is a flow chart of the information switch program 373.

When the information switch program 373 is initiated, the flow waits for the input event such as key inputting, mouse clicking or the like (step S1001).

When the input event occurs (step S1002), the transmission site is designated by the operator (step S1003), necessary information from among the still image information, the moving image information and the voice information is selected by using such the buttons 11 as shown in FIG. 7, and a determination button is depressed (step S1004).

Like the first and second embodiments, the still image and/or the moving image and the voice (i.e., image and voice information) obtained in the above selection are received from the transmission site 8 on the basis of negotiation with such the transmission site 8. Then, the received image is displayed on the monitor 2 and the received voice is outputted from the speaker 6 (step S1005).

When the voice level corresponding to the received and displayed image (e.g., still image in the present embodiment) changes (step S1006), if there is the image of which voice level changed higher than a predetermined value (step S1007), the new still image is received again from the transmission site 8 from which the voice-level changed image was received (step S1008). In this case, of course, such the transmission site 8 again photographs or takes the new still image by the camera 4 and then transmits the photographed image to the reception site 9.

After the new still image was received and displayed because the voice level of the previous still image became higher than the predetermined level, when such the voice level again becomes lower than the predetermined level in the step S1007, it may be stopped the displaying of the new still image currently performed on the monitor 2 (step S1010).

Further, if the operator does not wish to cancel the displaying of the still image once displayed, the step S1010 may be cancelled.

On the other hand, when the voice level corresponding to the received and displayed image (i.e., still image in the present embodiment) does not change in the step S1006, the still image displayed on the monitor 2 of the reception site 9 does not change.

When the termination event occurs (step S1009), the information switch program 373 terminates.

In the present embodiment, the information switch program 373 is stored at the side of the reception site 9. However, the program 373 may be stored at the side of the transmission site 8 and controlled by such the transmission site 8. Further, when such the program 373 stored in the transmission site 8 is read and initiated by the reception site 9, this program can be controlled from the reception site 9.

According to the present embodiment, as to the still image of which voice level is high, i.e., as to the still image of which importance is supposed to be high, the new still image is frequently received. Therefore, as the importance of the image becomes higher, such the image can be more real-time received and displayed. On the contrary, as to the still image of which voice level is low, such the still image is hardly updated, a transmission data amount on the network 7 can be reduced.

### Fourth Embodiment

In the fourth embodiment, at the time when the voice level of the voice corresponding to the image (i.e., still image or moving image) which is not yet transmitted becomes high, it is started to receive the still image or the moving image corresponding to such the voice from the transmission site. That is, only the voice is received from the transmission site in an initial state.

Like the second and third embodiments, the present embodiment also uses the system structured based on the entire block diagram illustrated in FIG. 1. However, only the information switch program 371 in FIG. 1 is replaced by an information switch program 374 (not shown).

FIG. 11 is a flow chart concerning execution procedure of the information switch program 374 which will be explained in detail hereinafter.

When the information switch program 374 is initiated, the flow waits for the input event such as key inputting, mouse clicking or the like (step S1101).

When the input event occurs (step S1102), the transmission site is designated by the operator (step S1103), necessary information from among the still image information, the moving image information and the voice information is selected by using such the buttons 11 as shown in FIG. 7, and the determination button is depressed (step S1104). It is assumed in the present embodiment that the still image and the voice were selected.

When the above selection is determined in the step S1104, a transmission instruction of the still image and the voice is sent from the reception site 9 to the transmission site 8, and the transmission site 8 prepares the transmission of the still image and the voice in accordance with such the instruction. However, only the voice is first received by the reception site 9 and outputted from the speaker 6 (step S1105).

Then, when the voice level of the outputted voice changes (step S1106), if the changed voice level is higher than a predetermined value (step S1107), negotiation with the transmission site 8 is performed such that the still image corresponding to the outputted voice is received from such the transmission site 8, and then the still image is actually received (step S1108).

On the other hand, if the voice level is not higher than the predetermined value, the still image is not received until such the voice level becomes higher than the predetermined value, and only the voice is continuously received.

Finally, when the termination event occurs (step S1109), the information switch program 374 terminates.

In the present embodiment, it was explained that the still image and the voice are transmitted. However, the moving image and the voice can be transmitted in the same manner.

By the above operation, since the image information concerning the important image of which voice level became high is selectively received, effective data receiving can be performed.

### Fifth Embodiment

In the fifth embodiment, image information controlling is performed on the transmission site of which voice level became high.

In the present embodiment, only the information switch program 371 in FIG. 1 is replaced by an information switch program 375 (not shown). Further, in order to change a photographing range of the camera 4 of the transmission site 8, a pan, zooming and the like can be controlled from the reception site 9 through the still image information transmission program 310 or the moving image information transmission program 320. Such the points are different from the first embodiment.

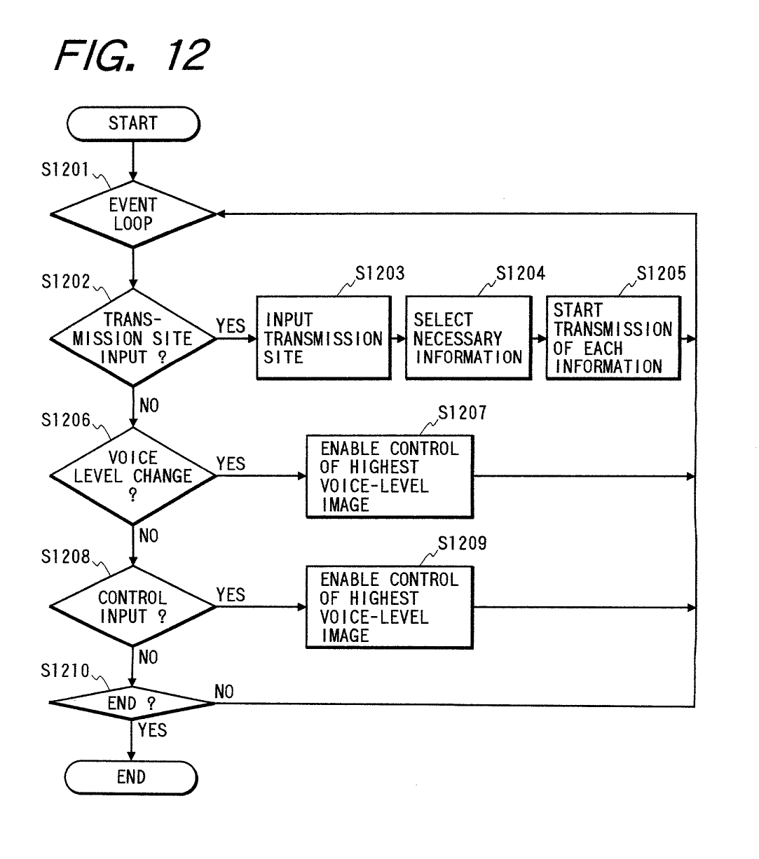

FIG. 12 is a flow chart concerning execution procedure of the information switch program 375 which will be explained in detail hereinafter.

When the information switch program 375 is initiated, the flow waits for the input event such as key inputting, mouse clicking or the like (step S1201).

When the input event occurs (step S1202), the transmission site is designated by the operator (step S1203), necessary information from among the still image information, the moving image information and the voice information is selected by using such the buttons 11 as shown in FIG. 7, and the determination button is depressed (step S1204).

Then, by performing negotiation with the transmission site 8 on the basis of the above selection, the still image or the moving image is received and displayed on the monitor 2, and the voice is received and outputted from the speaker 6 (step S1205).

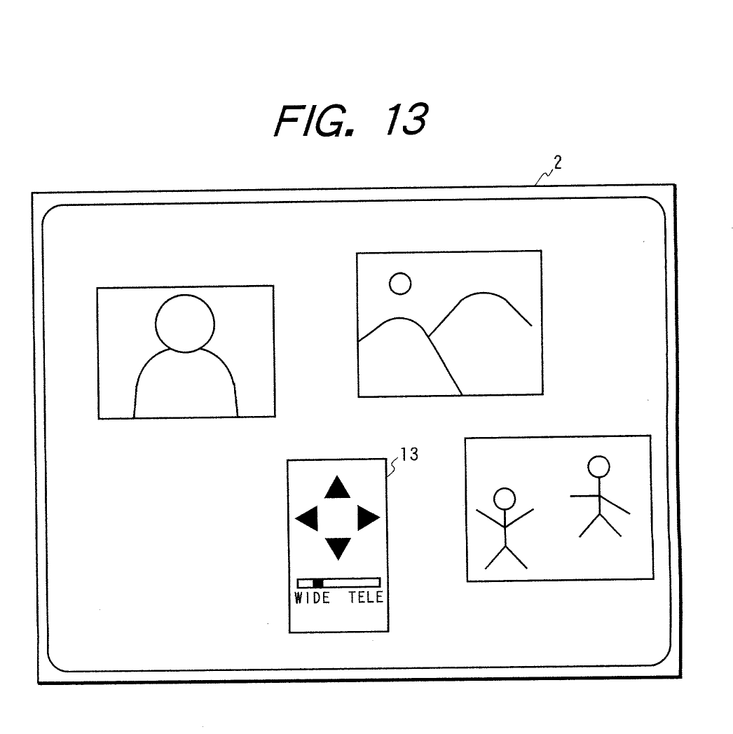

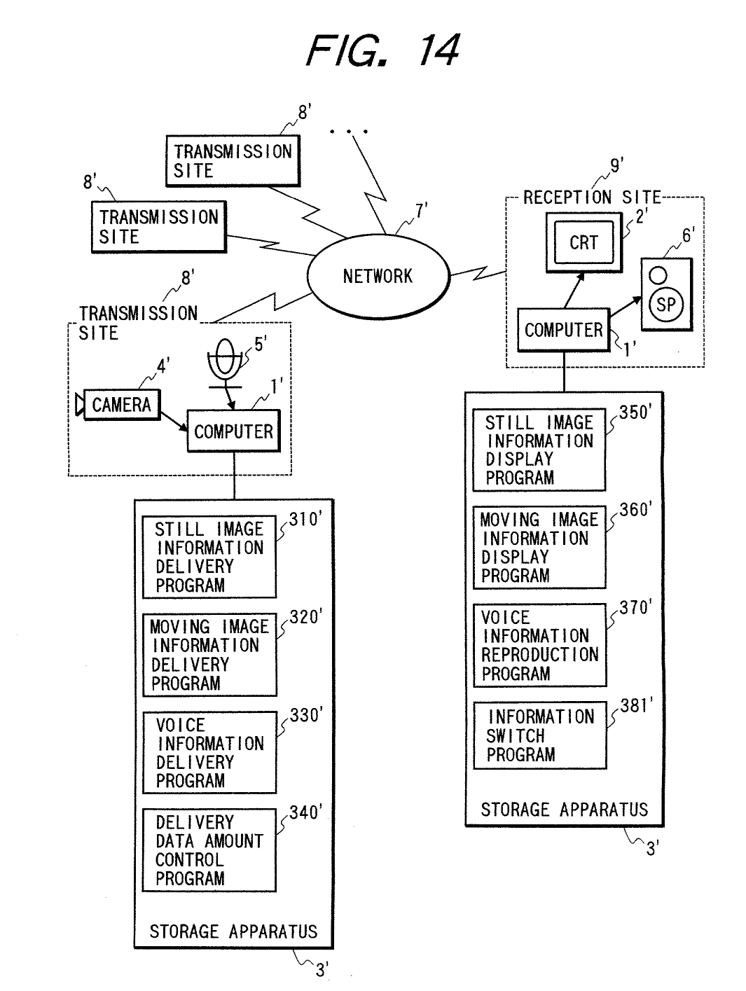

If the voice levels of the voices corresponding to the images currently displayed on the monitor 2 change (step S1206), the image (transmission site) of which voice level is highest is determined among the displayed images. Then, on the image of the determined transmission site, the target image to be camera controlled is switched or changed through a camera control window shown in FIG. 13, thereby enabling the camera controlling (step S1207).

Concretely, the camera controlling is to control a pan angle, a tilt angle and zooming magnification of the camera 4 from the reception site 9.

In the present embodiment, only the voice corresponding to the camera-controllable image is outputted from the speaker 6. Thus, a condition of the transmission site 8 to be camera controlled can be easily known or grasped from the reception site 9. Further, when only the voice level of the image corresponding to the transmission site to be camera controlled is made higher than those of the images corresponding to the other transmission sites, the same effect can be substantially derived.

Subsequently, the camera controlling is performed on the image of the transmission site which was made controllable in the step S1207, by the operator with use of the camera control window 13 (step S1208). Thus, the photographing range and the zooming magnification of the image transmitted from the transmission site is changed (step S1209).

Finally, when the termination event occurs (step S1210), the information switch program 375 terminates.

FIG. 13 shows an example of a camera control interfere. However, the present embodiment is not limited to this example. That is, if the camera can be controlled in numerals, the pan angle, the tilt angle and the zooming magnification may be inputted in such the numerals.

As a modification of the present embodiment, in the step S1207, the camera controlling may be performed on the image which is received from the transmission site of which voice level is lowest or the transmission site of which voice level most changes.

According to the present embodiment, it can be controlled the photographing state of the image which is supposed to be important because its voice level is high or highly changes.

Further, when the image which was received from the transmission site of which voice level is lowest is camera controlled, if its photographing range or the like is not appropriate, such the range or the like can be appropriately changed.

In the above-described embodiments, if yes in the steps S606, S906, S1006, S1106 and S1206 each judging whether or not the voice level changed, the flows advanced to the next steps S607, S907, S1007, S1107 and S1207, respectively. However, the present invention is not limited to such the procedure. That is, the flows may advance to the steps S607, S907, S1007, S1107 and S1207, every time a predetermined time elapses. By such procedure, the effects derived in the above-described embodiments can be also derived irrespective of whether or not the voice level changes.

For example, if the image is supposed to be important although its voice level is always high but does not change, the appropriate judging can be performed by applying such the structure.

Although the present invention is directed to the apparatus which has the above-described structure or the system which is composed of such the plural apparatuses, it is obviously understood that a method which performs the above-described processes and a storage medium which stores, in a computer readable state, a program to realize such the method are also included in the scope of the present invention.

In the above-described embodiments, when the controlling (i.e., image emphasizing, moving image reception controlling, still image reception controlling or the like) according to the voice level of each image is performed by the reception site (i.e., not transmission site), the various controlling can be easily performed in case of an internet in which the respective transmission sites are distant from others.

In the above-described embodiments, the various controlling were performed according to the voice level (i.e., volume) of the voice. However, the present invention is not limited to such the operation. That is, it is included in the scope of the present invention a case where the various controlling are performed according to contents of the voice.

For example, the controlling explained in the above-described embodiments may be performed according to a frequency (i.e., high frequency or low frequency), the contents recognized by voice recognition, or the like.

According to the above-explained embodiments of the present invention, since the various controlling is performed on the basis of the voice to be added to the image, when the image and the voice can be communicated between the transmission and reception sites, it can be provided the communication system or the image process method easily usable.

### Sixth Embodiment

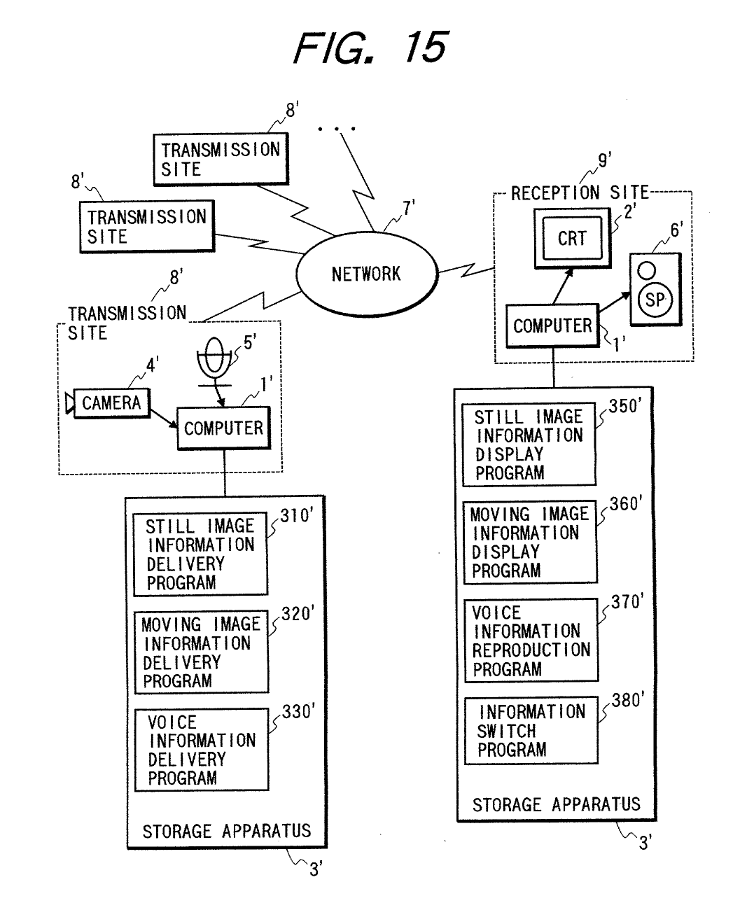

FIG. 15 is a block diagram of a communication system which bases the sixth to ninth embodiments.

In FIG. 15, reference numeral 1′ denotes a computer such as a personal computer (PC), a work station or the like which includes a CPU; 2′ denotes a monitor such as a CRT display or the like; 3′ denotes a storage apparatus which stores and holds a program and data; 4′ denotes a camera which inputs image information; 5′ denotes a microphone which inputs voice information; 6′ denotes a speaker which outputs a voice; 7′ denotes a network; 8′ denotes a transmission site; and 9′ denotes a reception site.

In the storage apparatus 3′ of the transmission site 8′, a still image information delivery program 310′, a moving image information delivery program 320′ and a voice information delivery program 330′ are stored.

In the storage apparatus 31 of the reception site 9′, a still image information display program 350′, a moving image information display program 360′, a voice information reproduction program 370′ and an information switch program 380′ are stored.

The still image information delivery program 310′ is the program which is used to capture or obtain a still image from the camera 4′ into the computer 1′ through a video board or the like, and transmit still image information through the network 7′.

The moving image information delivery program 320′ is the program which is used to capture or obtain a moving image from the camera 4′ into the computer 1′ through the video board or the like, and transmit moving image information through the network 7′.

The voice information delivery program 330′ is the program which is used to capture or obtain the voice from the microphone 5′ into the computer 1′ through a sound board or the like, and transmit the voice information through the network 7′.

The still image information display program 350′ is the program which is used to receive the still image information through the network 7′, and display the still image on the monitor 2′ of the computer 1.

The moving image information display program 360′ is the program which is used to receive the moving image information through the network 7′, and display the moving image on the monitor 2′ of the computer 1′.

The voice reproduction program 370′ is the program which is used to receive the voice information through the network 7′, reproduce the voice by the computer 1′, and output the reproduced voice by the speaker 6′.

By utilizing these programs through the network 7′, still image delivery, moving image delivery and voice delivery can be performed.

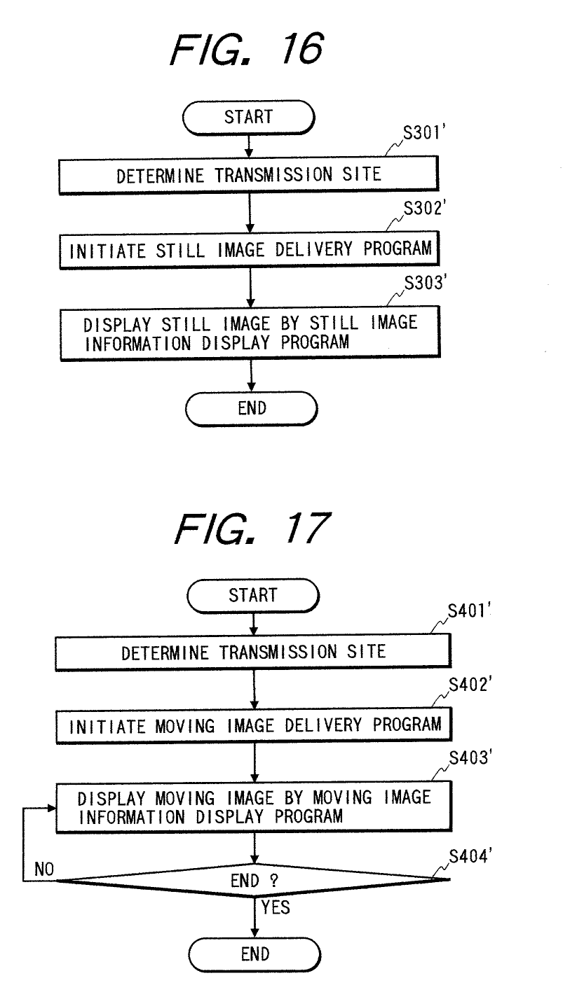

The still image delivery is realized by the procedure shown in a flow chart of FIG. 16.

If it is intended to display on the reception site 9′ the still image transmitted from any one of the transmission sites 8′, the inputting is performed to designate the transmission site (step S301′).

Then, the still image information delivery program 310′ of the designated transmission site 8′ is initiated (step S302′).

The still image information received from the transmission site 8′ through the network 7′ is displayed on the monitor 21 of the computer 1′ on the basis of the still image information display program 350′ (step S303′).

The moving image delivery is realized by the procedure shown in a flow chart of FIG. 17.

If it is intended to display on the reception site 9′ the moving image transmitted from any one of the transmission sites 8′, the inputting is performed to designate the transmission site (step S401′).

Then, the moving image information delivery program 320′ of the designated transmission site 8′ is initiated (step S402′).

The moving image information received from the transmission site 8′ through the network 71 is displayed on the monitor 2′ of the computer 1′ on the basis of the moving image information display program 360′ (step S403′).

Such the moving image displaying continues until an instruction to terminate the displaying is inputted from the reception site 9′ (step S404′).

Further, the voice delivery can be also realized by the same procedure as that for the moving image delivery shown in FIG. 17.

In the step same as S401′, if it is intended to reproduce at the reception site 9′ the voice transmitted from any one of the transmission sites 8′, the inputting is performed to designate the transmission site.

Then, in the step same as S402′, a voice encode program and the voice information delivery program 330′ of the designated transmission site 8′ are initiated.

In the step same as S403′, the voice information received from the transmission site 8′ through the network 7′ is reproduced and outputted from the speaker 6′ on the basis of the voice information reproduction program 370′.

In the step same as S404′, such the voice reproducing continues until an instruction to terminate the reproducing is inputted from the reception site 9′.

Further, an image and voice delivery system can be realized on the basis of the information switch program 380′ of the reception site 9′.

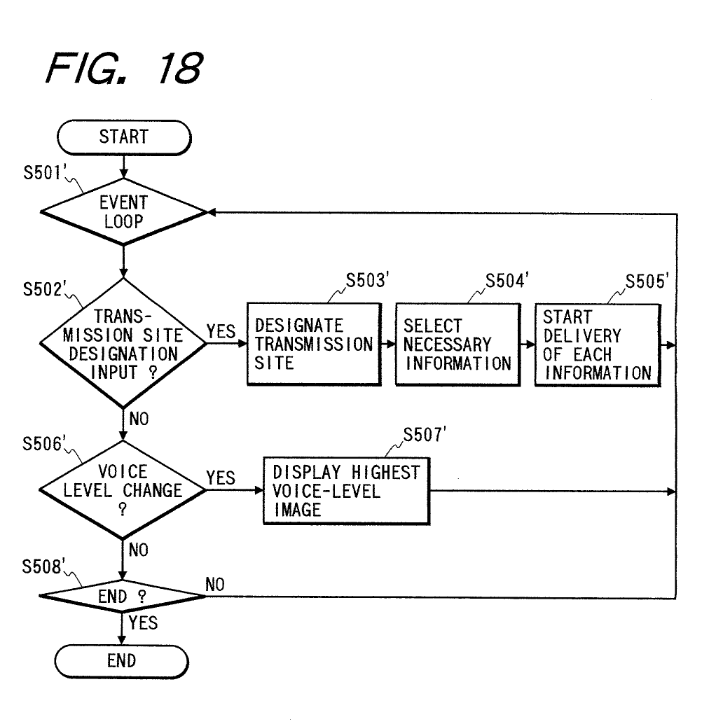

FIG. 18 is a flow chart of the information switch program 380′.

In FIG. 18, when the information switch program 380′ is initiated, the reception site 9′ waits for an input event by the operator such as key inputting, mouse clicking or the like (step S501′).

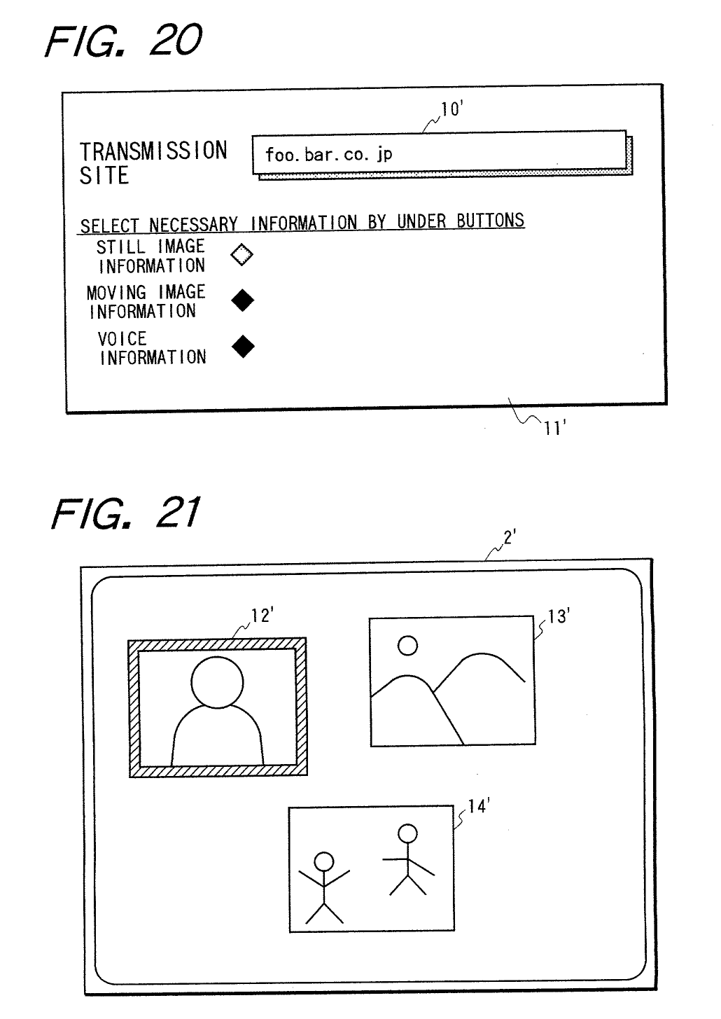

Then, when the input event to designate the transmission site 8′ occurs (step S502′), the transmission site is designated, e.g., in such a form as indicated by a numeral 10′ in FIG. 20 (step S503′), and the information which the operator intends to receive is selected from among the still image information or the moving image information and the voice information by selecting (i.e., clicking) buttons 11′ in FIG. 20 (step S504′).

In this case, it should be noted that the voice can be received together with the still image or the moving image. Therefore, any one of the still image, the moving image, the voice, the still image and the voice, and the moving image and the voice can be selected.

Then, the still image delivery, the moving image delivery or the voice delivery corresponding to the selected information is performed (step S505′).

By repeating the procedure in the steps S502′ to S505′, it is possible that the still image and the moving image (i.e., images 12′ to 14′) received from the plural transmission sites 8′ are displayed as shown in FIG. 21, and the voices corresponding to these images are outputted.

FIG. 21 is a view showing a case where the still image and moving image are received from the three transmission sites 8′ and the voices received from the three transmission sites 8′ are mixed and outputted.

Subsequently, in the case where “the still image and the voice” or “the moving image and the voice” is selected in the selection procedure of the step S504′, when a reproduced voice level of the voice appendant to each image (images 12′ to 14′) changes (step S506′), the displayed image (any one of images 12′ to 14′) which is transmitted from the transmission site 8′ and to which the highest level (volume) voice is appendant is emphasized and displayed (step S507′). In FIG. 21, since the level of the voice appended to the still image/moving image 12′ is highest, a frame of the displayed image 12′ is emphasized. Thus, the image which is most interesting can be emphasized and displayed. Such controlling is performed on the basis of the still image information display program 350′ or the moving image information display program 360′.

Further, when only the voice is selected in the selection procedure of the step S504′, the actual voice level is further enlarged to be reproduced in the step S506′ to clearly indicate the voice of such the highest voice-level transmission site.

For example, in FIG. 21, in a case where the three coupled of “the still image and the voice” (corresponding to displayed images 12′ to 14′) are received and outputted from the three transmission sites and only the voice is received and outputted from the other one transmission site (i.e., four voices are mixed and outputted), when the voice level from the transmission site transmitting only the voice is highest, such the voice is further enlarged, reproduced and outputted, whereby the most interesting voice can be emphasized and outputted.

Finally, when the termination event occurs (step S5081), the information switch program 380′ terminates.

It should be noted in the example of FIG. 21 that the frame representing the still image or the moving image is made remarkable. However, any other method for clearly indicating one of the plural images may be used.

Subsequently, the feature of the present embodiment to which the basic structure or form shown in FIG. 15 is applied will be explained hereinafter with reference to FIG. 14.

In FIG. 14, the information switch program 380′ of FIG. 15 is replaced by an information switch program 381′, and a delivery data amount control program 340′ is added to the storage apparatus 3′ of the transmission site 8′.

The delivery data amount control program 340′ is the program which is used to control the data amount transmitted from the transmission site 8′.

Controlling of such the data amount is realized by changing compression ratio of the still image delivered based on the still image information delivery program 310′, changing compression ratio and a frame rate of the moving image delivered based on the moving image information delivery program 320′, or the like.

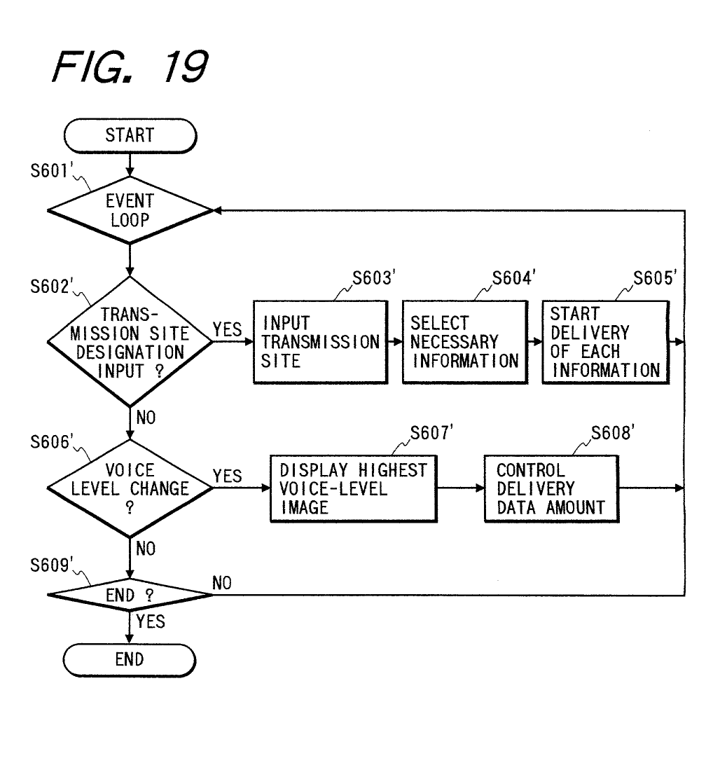

FIG. 19 is a flow chart of the information switch program 381′.

In FIG. 19, when the information switch program 381′ is initiated, the reception site 9′ waits for an input event by the operator such as key inputting, mouse clicking or the like (step S601′).

Then, when the input event to designate the transmission site 8′ occurs in the reception site 9′ (step S602′), an address of the transmission site 8′ is designated and inputted in the same manner as in the step S503′ of FIG. 18 (step S603′), and the information which the operator intends to receive is selected (step S604′). As described above, any one of the still image, the moving image, the voice, the still image and the voice, and the moving image and the voice can be selected.

Then, like the process in FIG. 18, the still image delivery, the moving image delivery or the voice delivery corresponding to the selected information is performed from the transmission site 8′ (step S605′).

Further, as explained in FIG. 18, by repeating the procedure in the steps S602′ to S605′, the plural still images and the moving images are displayed on the monitor (CRT) 2′ as shown in FIG. 21, and their corresponding voices are also outputted.

Then, in the case where “the still image and the voice” or “the moving image and the voice” is received and displayed as at least one of the images 12′ to 14′, when the level of the reproduced voice changes (step S606′), the image of the transmission site of which voice level is highest among the outputted voices is emphasized and displayed, such as the image 12′ of FIG. 21 (step S607′).

On the other hand, in a step S608′, controlling is performed to increase the delivery data amount on the displayed image (any one of images 12′ to 14′) corresponding to the transmission site which transmits the highest-level voice, and decrease the delivery data amounts on the other displayed images.

By such the controlling, the reception site 9′ emphasizes the displayed image according to the voice level in the steps S606′ and S607′, and also outputs an instruction signal to control the delivery data amount to each transmission site 8′. Therefore, in FIG. 21, the instruction signal to increase the delivery data amount is outputted to the transmission site 8′ corresponding to the image 12′. On the other hand, the instruction signal to decrease the delivery data amount is outputted to the transmission sites 8′ corresponding to the images 13′ and 14′.

In response to the instruction signal, as each transmission site 8′ controls the delivery data amount by actually controlling the compression ratio and the frame rate (in case of moving image) of the image, it transmits the still image and/or the moving image.

In the present embodiment, it should be noted that the still image is compressed in a JPEG (joint photographic expert group) compression system and the moving image is compressed in an MPEG (motion picture expert group) compression system. However, the compression system is not limited to them, but another systems may be used.

When the termination instruction event occurs (step S609′), the information switch program 3811 terminates.

In the above-described delivery data amount controlling, e.g., if an effective data band has been already determined due to limitations of network, controlling can be performed such that the total delivery data amount comes into such the band.

By the above-explained delivery data amount controlling, as in the basic structure and operation explained in FIGS. 15 and 18, the interesting displayed image of which voice level is high can be emphasized, and moreover such the interesting image can be displayed in higher image quality (or higher frame rate) than those of the other displayed images. Thus, the more convenient image easy to be used can be displayed.

In the above embodiments, the displayed image to which the highest voice-level (volume) voice is appendant is emphasized. However, the present invention is not limited to such the embodiments. That is, it is included in the scope of the present invention a case where the image corresponding to the voice of which level change (volume change) is largest is emphasized and displayed, or a case where the images corresponding to the several voices of which level changes are large are emphasized and displayed.

In the present embodiment shown in FIGS. 14 and 19, it is also possible that the voice (i.e., voice appendant to emphasized and displayed image) which is supposed to be important because its voice level is highest or its level change is large can be reproduced and outputted from the speaker 61 after its voice level is made larger than the actual level. In this case, the user can clearly recognize the relation between the emphasized and displayed image and the voice appendant thereto. Further, even if only the voice appendant to the emphasized and displayed image is outputted, the same effect can be derived.

Furthermore, on the image of the transmission site of which importance is supposed to be low because its voice level change is small, since such the image is displayed in the small data amount, the communication data amount can be reduced, whereby data communication can be smoothly performed.

In the above-described embodiments, the delivery data amount of the displayed image to which the highest-level voice or the large level-change voice is appendant was increased by simply decreasing the compression ratio or increasing the frame rate. However, if the maximum delivery data amount from each transmission site is limited because of a communication system, on the displayed image which is supposed to be important, it may be controlled that its compression ratio is increased and its frame rate is also increased (if frame rate is more important), or its compression ratio is decreased and its frame rate is also decreased (if image quality is more important).

### Seventh Embodiment

In the sixth embodiment, the delivery data amount of the displayed image was controlled according to the voice level, and further such the displayed image was processed (i.e., emphasized and displayed) by the predetermined display means. However, the present invention is not limited to such the embodiment.

In the seventh embodiment, by providing plural threshold values in voice level for switching the delivery data amount, the image is processed and displayed.

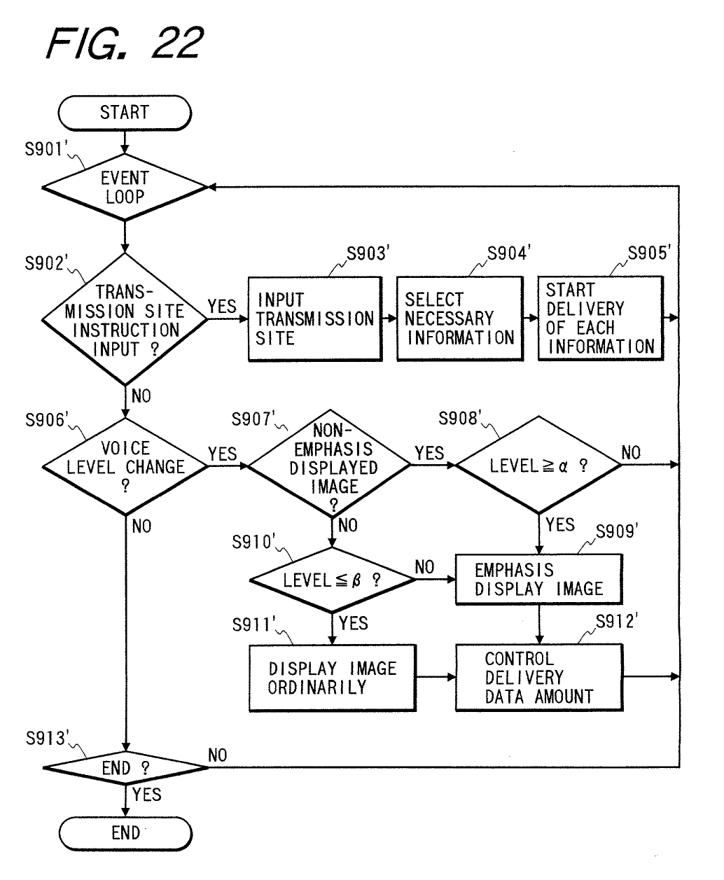

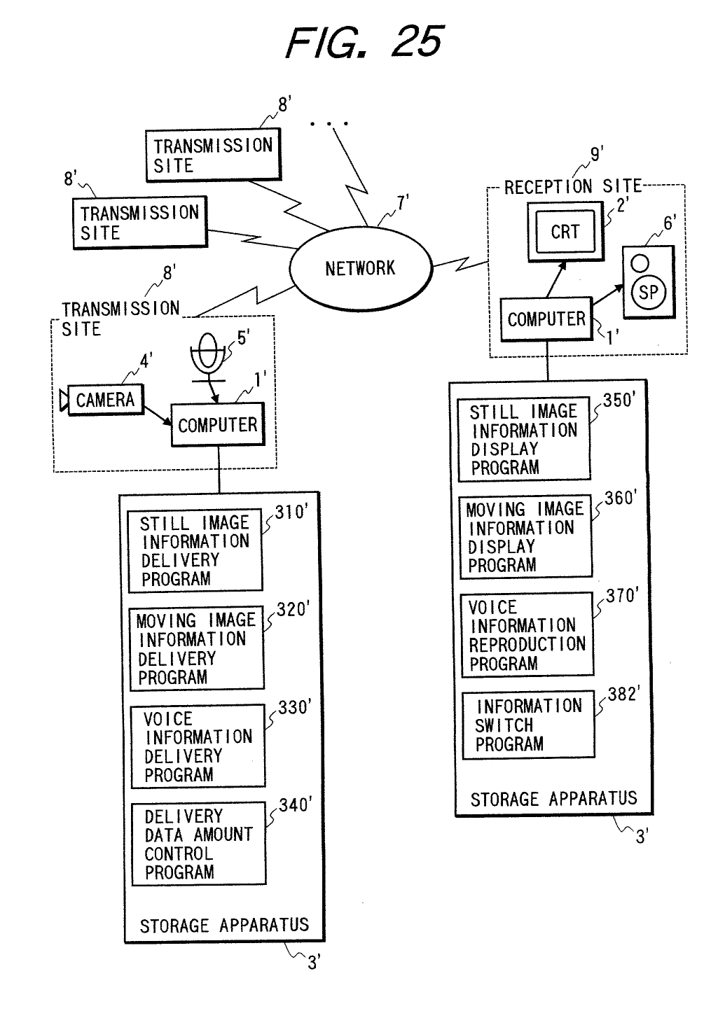

Hereinafter, the present embodiment will be explained with reference to FIGS. 22 and 25.

It should be noted that the system structure shown in FIG. 25 which is used in the present embodiment is basically the same as that shown in FIG. 14. That is, only the information switch program 381′ in FIG. 14 is replaced by an information switch program 382′ in FIG. 25.

For this reason, only the information switch program 382′ will be explained in detail hereinafter.

FIG. 22 is a flow chart showing operation procedure of the information switch program 382′.

In FIG. 22, initial steps S901′ to S905′ are substantially the same as the steps S601′ to S605′ in the sixth embodiment. That is, in these steps, the still image information, the moving image information and the voice information are delivered. By repeating the steps S902′ to S905′, the plural still images and/or the moving images shown in FIG. 21 are displayed on the CRT 2′ of the reception site 9′, and also the voices corresponding thereto are outputted.

Subsequently, when the reproduced voice level (any one of voices corresponding to images 12′ to 14′ in FIG. 21) changes (step S906′), it is judged whether or not its corresponding image is the emphasized and displayed image (step S907′).

In a case where the image judged in the step S907′ is not the emphasized and displayed image, i.e., the image 13′ or 14′ in FIG. 21, if such the voice level is not equal to or larger than a predetermined value α (step S908′), the flow returns to the event-loop step S901′ as it is. On the other hand, if such the voice level is equal to or larger than the predetermined value a (step S908′), such the judged image is also emphasized and displayed (step S909′). That is, it is possible in the present embodiment that the plural images are emphasized and displayed. For example, if the flow advances from the state shown in FIG. 21 to the step S909′, the image 13′ or 14′ is emphasized and displayed in addition to the image 12′.

Further, in a case where the image judged in the step S907′ is the image which has been already emphasized and displayed, if the voice level appendant thereto is not equal to or smaller than a predetermined value β (step S910′), the displaying of such the image is continued (step S909′). On the other hand, if such the voice level is equal to or smaller than the predetermined value β (step S910′), the emphasizing and displaying of the image is stopped, and the displaying state returns to the ordinary state (step S911′).

By such the processes, all of the displayed images of which appendant voice levels are within a predetermined level are emphasized and displayed. Therefore, all the images which are supposed to be relatively important can be emphasized and displayed.

Further, after the processes of the steps S906′ to S911′ are performed, the delivery data amount is controlled. That is, the controlling is performed to increase the delivery data amount of the image emphasized and displayed and decrease the delivery data amount of the image ordinarily displayed (step S912′).

Such the controlling is performed by outputting an instruction signal for controlling the delivery data amount from the reception site 9′ to each transmission site 8′.

Then, when the termination instruction event occurs (step S913′), the information switch program 382′ terminates.

It is assumed that the voice level α is larger than the voice level β. When magnitudes of these levels α and β are appropriately set, it can be prevented inconvenience that the image once emphasized and displayed soon returns to the ordinarily displayed image and thus the desired image becomes difficult to be recognized or found.

According to the present embodiment, the image which is relatively important or interesting can be emphasized and displayed, and further such the interesting image can be displayed in higher image quality (or higher frame rate) than those of the other images. Thus, the more convenient image which is easy to be used can be displayed.

Further, since the image which was emphasized and displayed because its voice level was once increased can be continuously emphasized and displayed to some extent, the user can easily recognize such the emphasized and displayed image.

In the present embodiment, it is also possible that the voice (i.e., voice appendant to emphasized and displayed image) which is supposed to be important because its voice level is highest or its level change is large can be reproduced and outputted from the speaker 6′ after its voice level is made larger than the actual level. In this case, the user can clearly recognize the relation between the emphasized and displayed image and the voice appendant thereto. Further, even if only the voice appendant to the emphasized and displayed image is outputted, the same effect can be derived.

### Eighth Embodiment

In the sixth and seventh embodiments, the delivery data amount of the displayed image was controlled according to the voice level. However, the present invention is not limited to such the embodiments.

In the eighth embodiment, the delivery data amount is controlled based on the image control information of the transmission site 8′.

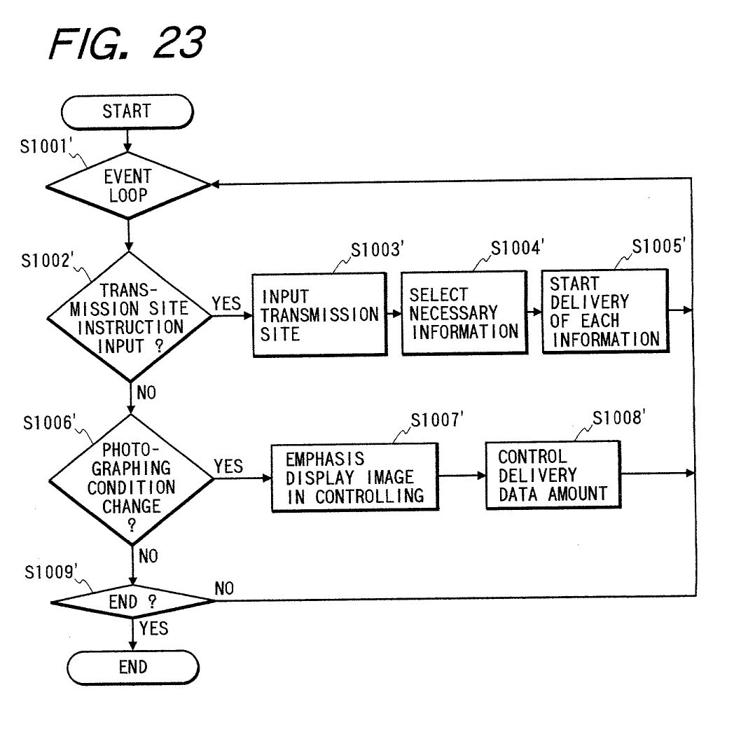

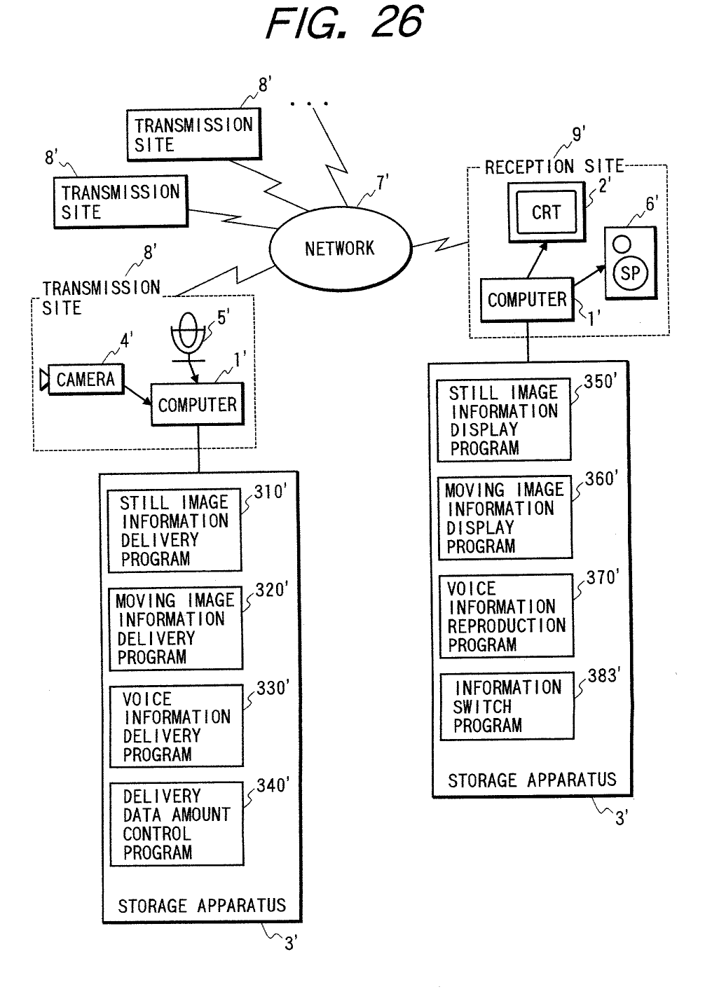

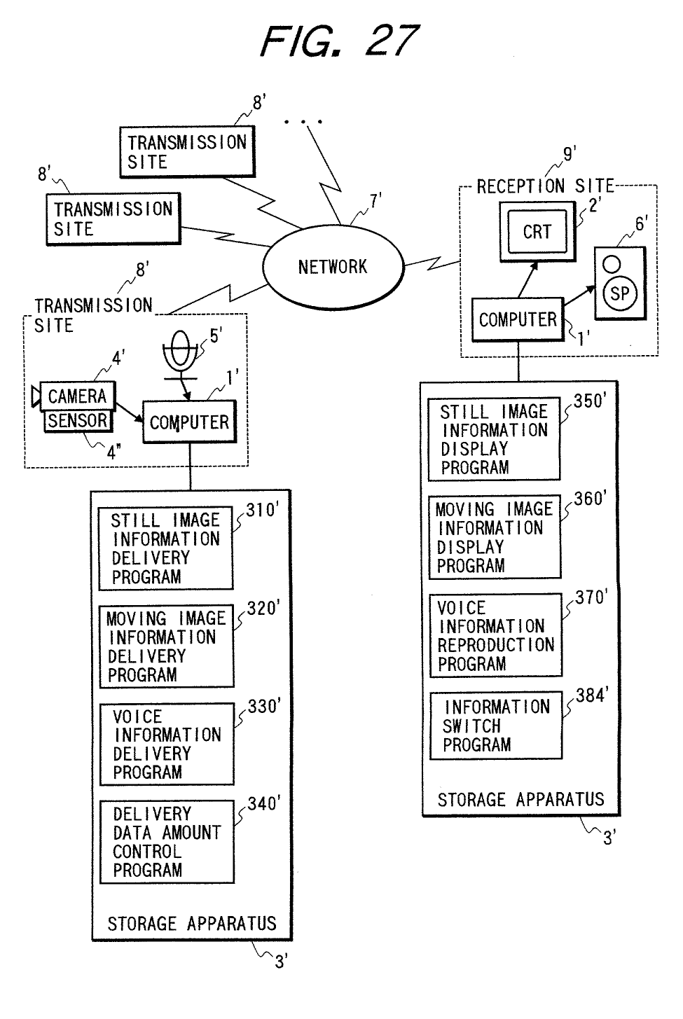

Hereinafter, the present embodiment will be explained with reference to FIGS. 23 and 26.

It should be noted that the system structure shown in FIG. 26 which is used in the present embodiment is basically the same as that shown in FIG. 14. That is, only the information switch program 381′ in FIG. 14 is replaced by an information switch program 383′ in FIG. 26.

Therefore, only the information switch program 383′ will be explained in detail hereinafter.

FIG. 23 is a flow chart showing operation procedure of the information switch program 383′.

Like the sixth and seventh embodiments, the still image information delivery, the moving image information delivery and the voice information delivery are initially performed (steps S1001′, S1002′, S1003′, S1004′, S1005′). By repeating the steps S1002′to S1005′, the plural still images and the moving images shown in FIG. 21 are displayed on the CRT 2′ of the reception site 9′, and the voices corresponding thereto are also outputted.

Subsequently, e.g., when a pan angle, a tilt angle and zooming magnification of each of the transmission sites from which the displayed images 12′ to 14′ (images 12′ to 14′ are assumed as moving images) are transmitted are moved or changed and thus the photographing condition of the displayed image changes (step S1006′), the displayed image corresponding to such the transmission site is emphasized and displayed such as the image 12′ in FIG. 21 (step S1007′).

In this case, the reception site 9′ judges the change of the photographing condition by receiving a control signal to control the photographing condition of each transmission site 8′.

Subsequently, controlling is performed to increase the delivery data amount of the displayed image corresponding to such the transmission site and decrease the delivery data amounts of the other displayed images (step S1008′). Such the controlling is performed by outputting the instruction signal to control the delivery data amount from the reception site 91 to each transmission site 8′.

When the termination instruction event occurs (step S1009′), the image information switch program 383′ terminates.

In the above-described delivery data amount controlling, e.g., if an effective data band has been already determined due to limitations of network, controlling can be performed such that the total delivery data amount comes into such the band.

In the present embodiment, the change in photographing condition is judged in the step S1006′ on the basis of the control information received from each transmission site. However, the present invention is not limited to such the operation. That is, it can be judged that the photographing condition changes, when a changing amount of the contents of displayed image is large.

According to the present embodiment, the image which is relatively important or interesting because its photographing condition changes can be emphasized and displayed. Further, such the interesting image can be displayed in higher image quality (or higher frame rate) than those of the other displayed images. Thus, the more convenient image which is easy to be used can be displayed.

In the present embodiment, it is also possible that the voice (i.e., voice appendant to emphasized and displayed image) which is supposed to be important because its voice level is highest or its level change is large can be reproduced and outputted from the speaker 6′ after its voice level is made larger than the actual level. In this case, the user can clearly recognize the relation between the emphasized and displayed image and the voice appendant thereto. Further, even if only the voice appendant to the emphasized and displayed image is outputted, the same effect can be derived.

Furthermore, on the image of the transmission site of which importance is supposed to be low because its voice level is low or its voice level change is small, since such the image is displayed in the small data amount, the communication data amount can be reduced, whereby data communication can be smoothly performed.

In the above-described embodiments, the delivery data amount of the displayed image to which the highest-level voice or the large level-change voice is appendant was increased by simply decreasing the compression ratio or increasing the frame rate. However, if the maximum delivery data amount from each transmission site is limited because of a communication system, on the display image which is supposed to be important, it may be controlled that its compression ratio is increased and its frame rate is also increased (if frame rate is more important), or its compression ratio is decreased and its frame rate is also decreased (if image quality is more important).

### Ninth Embodiment

In the sixth to eighth embodiments, the displayed image was emphasized or the delivery data amount (image quality, frame rate) was controlled in accordance with the voice level or the image photographing condition. However, the present invention is not limited to such the embodiments.

That is, in the eighth embodiment, by obtaining some information concerning the image information at the transmission site, the delivery data amount is changed, and also the displayed image is emphasized.

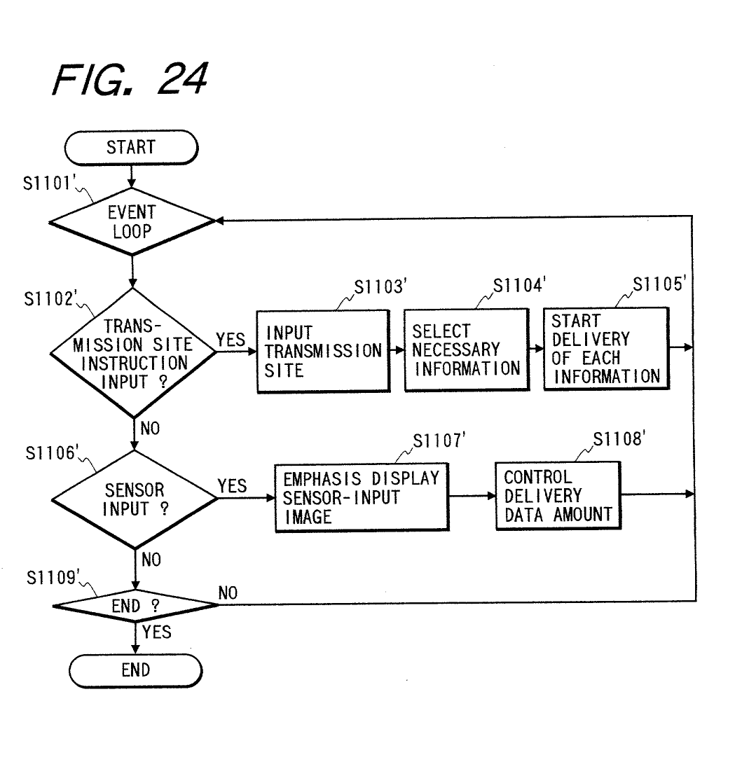

Hereinafter, the present embodiment will be explained with reference to FIGS. 24 and 27.

It should be noted that the system structure shown in FIG. 27 used in the present embodiment is basically the same as that shown in FIG. 14. That is, the information switch program 381′ in FIG. 14 is replaced by an information switch program 384′ and a heat sensor 4″ is newly added in FIG. 27.

Therefore, only the information switch program 384′ will be explained in detail hereinafter.

FIG. 24 is a flow chart showing operation procedure of the information switch program 384′.

Like the sixth to eighth embodiments, the still image information delivery, the moving image information delivery and the voice information delivery are performed (steps S1101′, S1102′, S1103′, S1104′, S1105′). By repeating the steps S1102′ to S1105′, the plural still images and the moving images shown in FIG. 21 are displayed on the CRT 2′ of the reception site 9′, and the voices corresponding thereto are also outputted.

In the present embodiment, as shown in FIG. 27, the heat sensor 4″ is appended to the camera 4′ of each transmission site 8′. Thus, since a temperature (air temperature, water temperature or the like) at photographing spot is detected by the heat sensor 4″, temperature information can be transmitted through a control line connecting the camera 4′ to the computer 1′ every time a temperature change occurs.

In the flow chart of FIG. 24, when the temperature information is inputted from the heat sensor 4″ of any one of the transmission sites and such the temperature information is equal to or larger than a predetermined temperature (step S1106′), the displayed image which is received from the transmission site corresponding to such the heat sensor 4″ is emphasized such as the image 12′ in FIG. 21 (step S1107′).

Subsequently, controlling is performed to increase the delivery data amount of such the displayed image to be emphasized and decrease the delivery data amounts of the other image information (step S1108′). Such the controlling is performed by outputting an instruction signal for controlling the delivery data amount from the reception site 9′ to each transmission site 8′.

When the termination instruction event occurs in the reception site 9′ (step S1109′), the information switch program 384′ terminates.

In the present embodiment, when the temperature information represents the temperature equal to or larger than the predetermined temperature in the step S1106′, the image corresponding to such the temperature information is emphasized and displayed. However, the present invention is not limited to such the operation. That is, it is included in the scope of the present invention a case where the image is emphasized and displayed when the temperature information represents the temperature equal to or lower than the predetermined temperature.

Further, in the step S1106′, the displaying according to the temperature represented by the temperature information may be performed. That is, it is included in the scope of the present invention a case where the displayed image corresponding to the temperature information representing the temperature equal to or lower than m degree is emphasized and displayed by using a blue frame, the displayed image corresponding to the temperature information representing the temperature larger than m degree and lower than n degree is emphasized and displayed by using an yellow frame, and the displayed image corresponding to the temperature information representing the temperature equal to or larger than n degree is emphasized and displayed by using a red frame. In this case, the delivery data amount is controlled to satisfy, e.g., “delivery data amount of blue-frame displayed image”<“delivery data amount of yellow-frame displayed image”<“delivery data amount of red-frame displayed image”.

In the above-described delivery data amount controlling, e.g., if an effective data band has been already determined due to limitations of network, controlling can be performed such that the total delivery data amount comes into such the band.

In the present embodiment, it is also possible that the voice (i.e., voice appendant to emphasized and displayed image) which is supposed to be important because its voice level is highest or its level change is large can be reproduced and outputted from the speaker 6′ after its voice level is made larger than the actual level. In this case, the user can clearly recognize the relation between the emphasized and displayed image and the voice appendant thereto. Further, even if only the voice appendant to the emphasized and displayed image is outputted, the same effect can be derived.

Further, when a frequency in reception of the temperature information from the heat sensor 4″ corresponding to one displayed image is small, it is judged that the change in temperature is small and the change in displayed image is also small. Thus, the controlling may be performed to decrease the delivery data amount of such the displayed image. In this case, the control information for decreasing the delivery data amount is transmitted from the reception site 9′ to such the transmission site.

In the above-described embodiments, the delivery data amount was simply changed according to the temperature information. However, if the maximum delivery data amount from each transmission site is limited because of a communication system, the compression ratio and the frame rate may be adaptively changed according to the temperature information.

As described above, according to the present embodiment, how to emphasize the displayed image corresponding to the temperature information obtained from the heat sensor 4″, the image quality and the frame rate can be adaptively determined according to the temperature represented by such the temperature information.

### Modified Embodiments

The present invention can be applied as a part of the system which is composed of the plural equipment or can be also applied as a part of the apparatus comprising one equipment.

The present invention is not limited to the apparatuses and the methods for realizing the above-described embodiments. That is, it is also included in the scope of the present invention a case where program codes of a software to realize the above-described embodiments are supplied to a computer (CPU or MPU) in the above system or the apparatus such that the system or the apparatus makes the various devices operative in order to realize the above-described embodiments in accordance with the supplied program codes.

In this case, the program codes themselves of the software realize the functions of the above-described embodiments. Thus, the program codes themselves and a means, e.g., a storage medium to store the program codes, for supplying the program codes to the computer are included in the scope of the present invention.

As such the storage medium to store the program codes, e.g., a floppy disk, a hard disk, an optical disk, a magneto-optical disk, a CD-ROM, a magnetic tape, a non-volatile memory card, a ROM or the like can be used.

Also, in addition to the case where the functions of the above-described embodiments are realized when the computer controls the various devices in accordance with only the supplied program codes, it is also included in the scope of the present invention the program codes in a case where the above-described embodiments are realized in cooperation with the OS (operating system) by which the program codes operate in the computer, an another application software, or the like.

Further, it is included in the scope of the present invention a case where the supplied program codes are stored into a memory provided for a function expansion board of the computer or a function expansion unit connected to the computer and, after that, a CPU or the like provided for the function expansion board or the function expansion unit executes a part or all of the actual processes on the basis of instructions of the program codes, and the above-described embodiments are realized by such the processes.

According to the above-described embodiments, in the communication system or apparatus which can communicate the image and the voice, it can be provided the communication system or the image process system which is convenient for use by the user.

Concretely, the reception image which is supposed to be important or interesting can be displayed in the state capable of being watched by the user as easy as possible, by utilizing the voice which is appendant to the reception image, the photographing conditions (e.g., pan angle, tilt angle, zooming magnification), and the like.

Further, the reception image which is supposed to be important or interesting can be displayed such that the image can be distinguished from the other reception images, by emphasizing its frame or the like.

The present invention can be variously modified and varied within the spirit and scope of the appended claims.

What is claimed is:

1. A communication system comprising a transmission apparatus for transmitting an image and a voice to be added to the image, and a reception apparatus for receiving the image and the voice, wherein
said transmission apparatus comprises transmission means capable of selectively transmitting the image and the voice to said reception apparatus; and
said reception apparatus comprises control means for controlling the image received from said transmission apparatus and causing predetermined display means to display the controlled image, on the basis of the voice transmitted by said transmission apparatus.

2. A system according to claim 1, wherein said one reception apparatus is connected to said plural transmission apparatuses to be able to selectively receive the image or the voice.

3. A system according to claim 2, wherein said control means causes said predetermined display means to display each of the images transmitted from said plural transmission apparatuses.

4. A system according to claim 1, wherein said reception apparatus comprises said predetermined display means.

5. A system according to claim 1, wherein said control means emphasizes the image transmitted from said transmission apparatus, in accordance with contents of the voice transmitted from said transmission apparatus.

6. A system according to claim 5, wherein the emphasizing is to enlarge the image.

7. A system according to claim 5, wherein the emphasizing is to emphasize an outer frame of the image.

8. A system according to claim 1, wherein said reception apparatus comprises a speaker for outputting the voice.

9. A system according to claim 1, wherein said control means controls a voice level of the voice transmitted from the predetermined transmission apparatus, in accordance with contents of the voices transmitted from said plural transmission apparatuses.

10. A system according to claim 1, wherein said control means controls resolution of the image transmitted from said transmission apparatus, in accordance with contents of the voice transmitted by said transmission apparatus.

11. A communication system comprising a transmission apparats for transmitting an image and a voice to be added to the image, and a reception apparatus for receiving the image and the voice, wherein
said transmission apparatus comprises transmission means capable of selectively transmitting the image and the voice to said reception apparatus, and
said reception apparatus comprises,
control means for controlling the image receiving from said transmission apparatus on the basis of the voice transmitted from said transmission apparatus, and
display control means for receiving the image transmitted from said transmission apparatus and causing predetermined display means to display the received image.

12. A system according to claim 11, wherein said control means performs, in accordance with contents of the voice transmitted from said transmission apparatus, the controlling such that the different kinds of images are received from said transmission apparatus from which the voice was received.

13. A system according to claim 12, wherein the different kinds of images include a still image and a moving image.

14. A system according to claim 11, wherein said control means selects whether or not the image is to be received from said transmission apparatus, in accordance with contents of the voice transmitted from said transmission apparatus.

15. A system according to claim 11, wherein said one reception apparatus is connected to said plural transmission apparatuses and can selectively receive the image or the voice.

16. A system according to claim 15, wherein said control means controls a voice level of the voice transmitted from predetermined one of said plural transmission apparatuses, in accordance with contents of the voices transmitted from said plural transmission apparatuses.

17. A system according to claim 16, wherein said predetermined transmission apparatus is one of said plural transmission apparatuses transmitting the voices, and is the transmission apparatus which transmitted the voice most satisfying a predetermined condition.

18. A system according to claim 15, wherein said control means controls voice levels of the voices transmitted from said transmission apparatuses other than a predetermined transmission apparatus, in accordance with contents of the voices transmitted from said plural transmission apparatuses.

19. A system according to claim 11, wherein said reception apparatus further comprises a speaker for outputting the voice.

20. A system according to claim 11, wherein said control means controls resolution of the image transmitted from said transmission apparatus, in accordance with contents of the voice transmitted from said transmission apparatus.

21. A communication system comprising a transmission apparatus for transmitting an image and a voice to be added to the image, and a reception apparatus for receiving the image and the voice, wherein
said transmission apparatus comprises,
transmission means capable of selectively transmitting the image and the voice to said reception apparatus, and
image pickup equipment control means for controlling a predetermined image pickup equipment to capture the image, and
said reception apparatus comprises allocation means for allocating a control right to control an operation of said predetermined image pickup equipment, on the basis of the voice transmitted from said transmission apparatus.

22. A system according to claim 21, wherein
said one reception apparatus is connected to said plural transmission apparatuses and can selectively receive the image or the voice, and
said allocation means allocates the control right such that the operation of said image pickup equipment corresponding to predetermined one of said plural transmission apparatuses, in accordance with contents of the voices transmitted from said plural transmission apparatuses.

23. A system according to claim 21, wherein said transmission apparatus comprises said image pickup equipment.

24. An information process apparatus which can receive an image and a voice to be added to the image, from a transmission apparatus, said information process apparatus comprising:
reception means capable of receiving the image and the voice to be added to the image; and
control means for controlling the image received by said reception means and displaying the controlled image on predetermined display means, on the basis of the voice received by said reception means.

25. An apparatus according to claim 24, wherein said information process apparatus is connected to said plural transmission apparatuses and can selectively receive the image or the voice.

26. An apparatus according to claim 25, wherein said control means can cause said predetermined display means to display each of the images transmitted from said plural transmission apparatuses.

27. An apparatus according to claim 24, wherein said information process apparatus comprises said predetermined display means.

28. An apparatus according to claim 24, wherein said control means emphasizes the image transmitted from said transmission apparatus, in accordance with contents of the voice transmitted from said transmission apparatus.

29. An apparatus according to claim 28, wherein the emphasizing is to enlarge the image.

30. An apparatus according to claim 28, wherein the emphasizing is to emphasize an outer frame of the image.

31. An apparatus according to claim 24, further comprising a speaker for outputting the voice.

32. An apparatus according to claim 25, wherein said control means controls a voice level of the voice transmitted from predetermined one of said plural transmission apparatuses, in accordance with contents of the voices transmitted from said plural transmission apparatuses.

33. An apparatus according to claim 24, wherein said control means controls resolution of the image transmitted from said transmission apparatus, in accordance with contents of the voice transmitted from said transmission apparatus.

34. An information process apparatus which can receive an image and a voice to be added to the image, from a transmission apparatus, said information process apparatus comprising:
reception means capable of receiving the image and the voice to be added to the image;
control means for controlling the image receiving of said reception means, on the basis of the voice received by said reception means; and
display control means for causing predetermined display means to display the image received by said reception means.

35. An apparatus according to claim 34, wherein said control means performs the controlling such that the different kinds of the images are received from said transmission apparatus from which the voice was received, in accordance with contents of the voice transmitted from said transmission apparatus.

36. An apparatus according to claim 35, wherein the different kinds of the images include a still image and a moving image.

37. An apparatus according to claim 34, wherein, said control means selects whether the image is to be received from said transmission apparatus, in accordance with contents of the voice transmitted from said transmission apparatus.

38. An apparatus according to claim 34, wherein said information process apparatus is connected to said plural transmission apparatuses and can selectively receive the image or the voice.

39. An apparatus according to claim 38, wherein said control means controls a voice level of the voice transmitted from predetermined one of said plural transmission apparatuses, in accordance with contents of the voices transmitted from said plural transmission apparatuses.

40. An apparatus according to claim 39, wherein said predetermined transmission apparatus is one of said plural transmission apparatuses transmitting the voices, and is the transmission apparatus which transmitted the voice most satisfying a predetermined condition.

41. An apparatus according to claim 38, wherein said control means controls voice levels of the voices transmitted from said transmission apparatuses other than a predetermined transmission apparatus, in accordance with contents of the voices transmitted from said plural transmission apparatuses.

42. An apparatus according to claim 34, wherein said information process apparatus further comprises a speaker for outputting the voice.

43. An apparatus according to claim 34, wherein said control means controls resolution of the image transmitted from said transmission apparatus, in accordance with contents of the voice transmitted from said transmission apparatus.

44. An information process apparatus which can communicate with a transmission apparatus having a predetermined image pickup equipment for capturing an image, said information process apparatus comprising:
reception means capable of receiving the image and a voice to be added to the image; and
allocation means for allocating a control right to control operation of said image pickup equipment, on the basis of the voice received by said reception means.

45. An apparatus according to claim 44, wherein
said information process apparatus is connected to said plural transmission apparatuses and can selectively receive the image or the voice, and
said allocation means allocates the control right such that the operation of said image pickup equipment corresponding to predetermined one of said plural transmission apparatuses can be controlled, in accordance with contents of the voices transmitted from said plural transmission apparatuses.

46. An information process method which can receive an image and a voice to be added to the image, from a transmission apparatus, said method comprising:
a reception step of receiving the image and the voice to be added to the image; and
a control step of controlling the image received in said reception step and causing a predetermined display means to display the controlled image, on the basis of the voice received in said reception step.

47. An information process method which can receive an image and a voice to be added to the image, from a transmission apparatus, said method comprising:
a reception step of receiving the image and the voice to be added to the image;
a control step of controlling the image receiving in said reception step, on the basis of the voice received in said reception step; and
a display control step of causing a predetermined display means to display the image received in said reception step.

48. An information process method which can communicate with a transmission apparatus having a predetermined image pickup equipment for capturing an image, said method comprising:
a reception step of receiving the image and a voice to be added to the image; and
an allocation step of allocating a control right to control operation of the image pickup equipment, on the basis of the voice received in said reception step.

49. A storage medium which stores, in a computer readable state, a program supplied to an apparatus which can receive an image and a voice to be added to the image, from a transmission apparatus, said program comprising:
a reception step of receiving the image and the voice to be added to the image; and
a control step of controlling the image received in said reception step and causing a predetermined display means to display the controlled image, on the basis of the voice received in said reception step.

50. A storage medium which stores, in a computer readable state, a program supplied to an apparatus which can receive an image and a voice to be added to the image, from a transmission apparatus, said program comprising:
a reception step of receiving the image and the voice to be added to the image;
a control step of controlling the image receiving in said reception step, on the basis of the voice received in said reception step; and
a display control step of causing a predetermined display means to display the image received in said reception step.

51. A storage medium which stores, in a computer readable state, a program supplied to an apparatus which can communicate with a transmission apparatus having a predetermined image pickup equipment for capturing an image, said program comprising:
a reception step of receiving the image and a voice to be added to the image; and
an allocation step of allocating a control right to control operation of the image pickup equipment, on the basis of the voice received in said reception step.

52. A system according to claim 1, wherein the controlling by said control means is performed on the basis of a voice level of the voice.

53. A communication system comprising a transmission apparatus for transmitting an image and a voice to be added to the image, and a reception apparatus for receiving the image and the voice, wherein
said transmission apparatus comprises,
data amount control means for controlling a data amount of the image on the basis of a level of the voice to be added to the image, and
transmission means for transmitting the image of which data amount was controlled by said data amount control means, and
said reception apparatus comprises,
reception means for receiving the image transmitted by said transmission means, and
display control means for causing predetermined display means to display the image received by said reception means.

54. A system according to claim 53, wherein said reception apparatus further comprises image control means for controlling the image received by said reception means, in accordance with the level of the voice.

55. A system according to claim 53, wherein said data amount control means controls the data amount of the image on the basis of plural threshold values.

56. A system according to claim 54, wherein said image control means controls the image received by said reception means, on the basis of plural threshold values.

57. A system according to claim 54, wherein the controlling by said image control means is to emphasize the image.

58. A system according to claim 57, wherein the emphasizing of the image is to emphasize an outer frame of the image.

59. A system according to claim 53, wherein said communication system comprises the plural transmission apparatuses, said reception means receives the plural images transmitted from said transmission means of said plural transmission apparatuses, and said display control means causes said predetermined display means to simultaneously display the plural images.

60. An information process apparatus which connects a reception apparatus receiving an image and a voice and transmits the image and the voice to be added to the image, comprising:
data amount control means for controlling a data amount of the image, on the basis of a level of the voice to be added to the image; and
transmission means for transmitting the image controlled by said data amount control means.

61. An information process method which transmits an image and a voice to be added to the image, to a reception apparatus, comprising:
a data amount control step of controlling a data amount of the image, on the basis of a level of the voice to be added to the image; and
a transmission step of transmitting the image controlled in said data amount control step.

62. A storage medium which stores, in a computer readable state, an information process program which is used to transmit an image and a voice to be added to the image, to a reception apparatus, said program comprising:
a data amount control step of controlling a data amount of the image, on the basis of a level of the voice to be added to the image; and
a transmission step of transmitting the image controlled in said data amount control step.

63. An information process apparatus which is connected to a transmission apparatus capable of transmitting an image and a voice to be added to the image, and controlling a data amount at a time when the image is transmitted, said information process apparatus comprising:
reception means for receiving the image and the voice transmitted by said transmission apparatus; and
output means for outputting instruction information for controlling the data amount of the image transmitted by said transmission apparatus, on the basis of a level of the voice received by said reception means.

64. An apparatus according to claim 63, further comprising display control means for displaying the image received by said reception means, on a monitor.

65. An apparatus according to claim 63, further comprising a monitor for displaying the image received by said reception means.

66. An apparatus according to claim 64, wherein
said information process apparatus is connected to plural transmission apparatuses including said transmission apparatus,
said reception means receives the plural images and the voices transmitted from said plural transmission apparatuses, and
said display control means simultaneously displays the plural images and the voices received by said reception means, on said monitor.

67. A method for controlling a reception apparatus which is connected to a transmission apparatus capable of transmitting an image and a voice to be added to the image, and of controlling a data amount at a time when the image is transmitted, said method comprising:
a reception step of receiving the image and the voice transmitted by the transmission apparatus; and
an output step of outputting instruction information for controlling the data amount of the image transmitted by the transmission apparatus, on the basis of a level of the voice received in said reception step.

68. A storage medium which stores, in a computer readable state, a control program for controlling a reception apparatus which is connected to a transmission apparatus capable of transmitting an image and a voice to be added to the image, and of controlling a data amount at a time when the image is transmitted, said program comprising:
a reception step of receiving the image and the voice transmitted by the transmission apparatus; and
an output step of outputting instruction information for controlling the data amount of the image transmitted by the transmission apparatus, on the basis of a level of the voice received in said reception step.

69. A communication system which comprises a transmission apparatus for transmitting an image photographed by predetermined image pickup means, and a reception apparatus for receiving the transmitted image, wherein
said transmission apparatus comprises transmission means for transmitting the image, and
said reception apparatus comprises,
reception means for receiving the image transmitted by said transmission means,
image control means for controlling the image received by said reception means, in accordance with an environment in which the image is photographed, and
display control means for causing predetermined display means to display the image controlled by said image control means.

70. A system according to claim 69, wherein the environment in which the image is photographed is either one of a pan angle, a tilt angle and zooming magnification of said image pickup means in case of photographing.

71. A system according to claim 69, wherein the environment in which the image is photographed is a temperature.

72. A system according to claim 71, wherein said transmission apparatus comprises a sensor for detecting the temperature.

73. A communication system which comprises a transmission apparatus for transmitting an image photographed by predetermined image pickup means, and a reception apparatus for receiving the transmitted image, wherein
said transmission apparatus comprises,
data amount control means for controlling a data amount of the image in accordance with an environment in which the image is photographed, and
transmission means for transmitting the image controlled by said data amount control means, and
said reception apparatus comprises,
reception means for receiving the image transmitted by said transmission means, and
display control means for causing predetermined display means to display the image received by said reception means.

74. A system according to claim 73, wherein the environment in which the image is photographed is either one of a pan angle, a tilt angle and zooming magnification of said image pickup means in case of photographing.

75. A system according to claim 73, wherein the environment in which the image is photographed is a temperature.

76. A system according to claim 75, wherein said transmission apparatus comprises a sensor for detecting the temperature.
